(19) United States
(12) Patent Application Publication
(10) Pub. No.: US 2022/0264908 A1
(43) Pub. Date: Aug. 25, 2022

(54) ISOLATED PLANT PROTEIN

(71) Applicant: Eat JUST, Inc., San Francisco, CA (US)

(72) Inventors: Meng LI, San Francisco, CA (US); Michael JAMROS, Oakland, CA (US); Swetha MAHADEVAN, Richmond, CA (US); Viviane LANQUAR, San Carlos, CA (US); Camilla HEROLD, San Jose, CA (US); Peter LICARI, Fremont, CA (US)

(21) Appl. No.: 17/675,732

(22) Filed: Feb. 18, 2022

Related U.S. Application Data
(60) Provisional application No. 63/151,497, filed on Feb. 19, 2021.

(51) Int. Cl. A23J 1/14

(52) U.S. Cl. CPC A23J 1/148

(57) ABSTRACT

An isolated plant protein comprising both native and denatured proteins, food compositions containing such isolates, and methods for preparing isolated plant protein are disclosed. In some embodiments, the hardness and gel elasticity of the isolated plant protein can be controlled by controlling the amounts of native protein and denatured protein present in the plant protein isolate.

### FIELD OF THE INVENTION

The present disclosure relates to isolated plant proteins that comprise native and denatured protein. The texture of a food product comprising the isolated plant protein can be determined by the amounts of native proteins and denatured proteins.

### BACKGROUND

Use of plant-based proteins such as soy and pea as animal protein substitutes have garnered increasing attention as consumers seek alternatives to conventional animal-based products to reduce the environmental impacts of animal husbandry and to improve dietary options that minimize the negative implications of consuming many animal protein products.

Conventional methods and processes used for extracting plant protein isolates and concentrates include alkaline extraction and acid precipitation (wet process), and generally produces proteins that are denatured. The functional properties, e.g., the hardness, gel elasticity, gelling, foaming or emulsifying properties of the protein compositions or food composition comprising isolated proteins is not predictable because the amounts of native and denatured proteins present in the isolated protein is not controlled. The inability to control the amount of native and denatured proteins in isolated plant proteins makes the resulting protein compositions unsuitable for certain applications. Thus, there remains a need for processes of isolating plant-based proteins with physical characteristics and organoleptic properties desirable for the production of food products, including alternatives to conventional products containing animal proteins.

### BRIEF SUMMARY OF THE INVENTION

In one aspect, the present disclosure provides an isolated plant protein comprising both native (undenatured) and denatured proteins. The hardness and/or apparent modulus (gel elasticity) of the isolated plant protein increases with increasing amounts of native protein. In one embodiment, the hardness of the isolated plant protein increases with increasing amounts of native proteins. In one embodiment, the apparent modulus of the isolated plant protein increases with increasing amounts of native proteins. In an embodiment, both the hardness and apparent modulus of the isolated plant protein increases with increasing amounts of native protein. In an embodiment, the isolated plant protein is cross-linked by exposure to a protein cross-linking enzyme.

In one embodiment of the isolated plant protein, the amount of native protein, by weight, is between 10% and 95% and any range between 10% and 95%. In one embodiment of the isolated plant protein, the amount of the denatured protein, by weight, is between 10% and 95% or any range between 10% and 95%.

In one embodiment of the isolated plant protein, the isolated plant protein may be isolated from dry beans, lentils, fava beans, dry peas, chickpeas, cowpeas, bambara beans, pigeon peas, lupins, vetches, adzuki, common beans, fenugreek, long beans, lima beans, runner beans, tepary beans, soybeans (Glycine max), or mucuna beans. In any embodiments of the isolated plant protein, the plant may comprise Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the isolated plant protein is isolated from mung beans (Vigna radiata). In other embodiments, the isolated plant protein may be isolated from almonds and other nuts, seeds such as sesame seeds, sunflower seeds, and other commonly consumed nuts, fruits and seeds.

In some embodiments, the hardness of the isolated protein is greater than 2 N, 3 N, 4 N, 5 N, 6 N, 7 N, 8 N, 9 N, 10 N, 15 N, 20 N, 25 N, or 30 N. In some embodiments, the hardness of the isolated protein is between 2 N and 50 N, between 2 N and 45 N, between 2 N and 40 N, between 2 N and 35 N, between 2 N and 30 N, between 2 N and 25 N, between 2 N and 20 N, between 2 N and 15 N, between 2 N and 10 N, between 2 N and 5 N, between 3 N and 35 N, between 3 N and 30 N, between 3 N and 25 N, between 3 N and 20 N, between 3 N and 15 N, between 3 N and 10 N, or between 3 N and 5 N.

In some embodiments, the apparent modulus of the isolated plant protein is between 10,000 Pa and 150,000 Pa, or any range between 10,000 Pa and 150,000 Pa.

In an embodiment, the isolated plant protein is cross-linked by exposure to one or more protein cross-linking enzymes. In one embodiment the amount of cross-linking enzyme is between 0.0001% to 0.5%. In one embodiment, the protein cross-linking enzyme is selected from the group consisting of transglutaminase, sortase, subtilisin, tyrosinase, laccase, peroxidase, and lysyl oxidase.

In one aspect, the present disclosure provides a food composition or a food ingredient comprising isolated plant protein. The isolated plant protein comprises both native (undenatured) and denatured proteins. The hardness and/or apparent modulus (gel elasticity) of the food composition or a food ingredient increases with increasing amounts of native protein. In one embodiment, the hardness of the food composition or a food ingredient increases with increasing amounts of native proteins. In one embodiment, the apparent modulus of the food composition or a food ingredient increases with increasing amounts of native proteins. In an embodiment, both the hardness and apparent modulus of the food composition or a food ingredient increases with increasing amounts of native protein in the food composition or a food ingredient. In an embodiment, the isolated plant protein in the food composition or a food ingredient is cross-linked by exposure to a protein cross-linking enzyme. In one embodiment the amount of cross-linking enzyme of the food composition or food ingredient is between 0.0001% to 0.5%.

In one embodiment, the food composition or food ingredient comprises isolated plant protein, wherein the amount of the native protein of the isolated plant protein, by weight, is between 10% and 95%, or any range between 10% and 95%. In one embodiment, the food composition or food ingredient comprises isolated plant protein, wherein the amount of the denatured protein, by weight, is between 10% and 95% and any range between 10% and 95%.

In some embodiments, the hardness of the food composition or food ingredient comprising isolated plant protein is greater than 200 g, or between 3000 g, or any range between 200 g and 3000 g. In some embodiments, the hardness of the food composition or food ingredient is greater than 2 N, 3 N, 4 N, 5 N, 6 N, 7 N, 8 N, 9 N, 10 N, 15 N, 20 N, 25 N, or 30 N. In some embodiments, the hardness of the isolated protein is between 2 N and 50 N, between 2 N and 45 N, between 2 N and 40 N, between 2 N and 35 N, between 2 N and 30 N, between 2 N and 25 N, between 2 N and 20 N, between 2 N and 15 N, between 2 N and 10 N, between 2 N and 5 N, between 3 N and 35 N, between 3 N and 30 N, between 3 N and 25 N, between 3 N and 20 N, between 3 N and 15 N, between 3 N and 10 N, or between 3 N and 5 N.

In some embodiments, the apparent modulus of the food composition or food ingredient comprising isolated plant protein is between 10,000 Pa and 150,000 Pa, or any range between 10,000 Pa and 150,000 Pa.

In any embodiments of a food composition or food ingredient comprising isolated plant protein, the amount of the isolated plant protein, by weight, is between 10% and 95% and any range between 10% and 95%. In any embodiments of a food composition or food ingredient comprising isolated plant protein, the amount of the denatured protein, by weight, is between 10% and 95% and any range between 10% and 95%.

In any embodiments of the food composition or food ingredient comprising isolated plant protein, the isolated plant protein may comprise proteins isolated from dry beans, lentils, fava beans, dry peas, chickpeas, cowpeas, bambara beans, pigeon peas, lupins, vetches, adzuki, common beans, fenugreek, long beans, lima beans, runner beans, tepary beans, soybeans (Glycine max), or mucuna beans. In any embodiments of the food composition or food ingredient comprising isolated plant protein, the isolated protein may be isolated from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the isolated plant protein comprises proteins isolated from mung beans (Vigna radiata). In other embodiments, the isolated plant protein may comprise proteins isolated from almonds and other nuts, seeds such as sesame seeds, sunflower seeds, and other commonly consumed nuts, fruits and seeds.

In an embodiment of a food composition or food ingredient comprising isolated plant protein, the isolated plant proteins are cross-linked by exposure to one or more protein cross-linking enzymes. In one embodiment the amount of cross-linking enzyme of the food composition or food ingredient is between 0.0001% to 0.5%. In one embodiment, the protein cross-linking enzyme is selected from the group consisting of transglutaminase, sortase, subtilisin, tyrosinase, laccase, peroxidase, and lysyl oxidase.

In one embodiment, a method of controlling the hardness and/or apparent modulus of a food composition or food ingredient comprising isolated plant protein is provided. The method comprises providing isolated plant proteins that comprise both native and denatured proteins, identifying a desired hardness and/or apparent modulus, and determining the amount of native protein needed to achieve the desired hardness and/or apparent modulus. The hardness and/or apparent modulus of the food composition or food ingredient increases with use of increasing amounts of native protein used to prepare the food composition or food ingredient. In this method of controlling the hardness and/or apparent modulus of a food composition or food ingredient, the amount of the isolated plant protein in the food composition or food ingredient, by weight, is between 10% and 95%, or any range between 10% and 95%. In one embodiment, the amount of the denatured protein, by weight, is between 10% and 95%, or any range between 10% and 95%.

In one embodiment of controlling the hardness and/or apparent modulus of a food composition or food ingredient, the amount of the isolated plant protein in the food composition or food ingredient, by weight, is between 10% and 95%, or any range between 10% and 95%. In one embodiment, the amount of the denatured protein, by weight, is between 10% and 95%, or any range between 10% and 95%.

In one embodiment of the methods of controlling the hardness and/or apparent modulus of a food composition or food ingredient, the isolated plant protein may be isolated from dry beans, lentils, fava beans, dry peas, chickpeas, cowpeas, bambara beans, pigeon peas, lupins, vetches, adzuki, common beans, fenugreek, long beans, lima beans, runner beans, tepary beans, soybeans, or mucuna beans. In any embodiments of the method of controlling the hardness and/or apparent modulus, the isolated plant protein may be isolated from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the isolated plant protein may be isolated from mung beans (Vigna radiata). In other embodiments, the isolated plant protein may be isolated from almonds and other nuts, seeds such as sesame seeds, sunflower seeds, and other commonly consumed nuts, fruits and seeds.

In some embodiments of controlling the hardness and/or apparent modulus of a food composition or food ingredient, the hardness of the food composition or food ingredient is greater than 200 g, or between 3000 g, or any range between 200 g and 3000 g.

In some embodiments of controlling the hardness and/or apparent modulus of a food composition or food ingredient, the apparent modulus of the food composition or food ingredient is between 10,000 Pa and 150,000 Pa, or any range between 10,000 Pa and 150,000 Pa.

In an embodiment of controlling the hardness and/or apparent modulus of a food composition or food ingredient, the isolated plant protein in the food composition or food ingredient are cross-linked by exposure to one or more protein cross-linking enzymes. In one embodiment the amount of cross-linking enzyme of the food composition or food ingredient is between 0.0001% to 0.5%. The cross-linking enzyme is exposed to the food composition or food ingredient for a period of between 1 second and two hours. After exposure to the cross-linking enzyme for a desired amount of time, the enzyme is inactivated by exposure to heat or other known methods of inactivating enzymes. In one embodiment, cross-linking enzyme is inactivated by exposure to high-temperature, short-time (HTST), high-temperature, long-time (HTLT) or other known heat exposure methods, In one embodiment, the protein cross-linking enzyme is selected from the group consisting of transglutaminase, sortase, subtilisin, tyrosinase, laccase, peroxidase, glucose oxidase and lysyl oxidase.

In one embodiment, a method of preparing a food composition or food ingredient comprising isolated plant protein is provided. The method comprises providing isolated plant proteins that comprise both native and denatured proteins, identifying a desired hardness and/or apparent modulus, and determining the amount of native protein needed to achieve the desired hardness and/or apparent modulus. The hardness and/or apparent modulus of the food composition or food ingredient increases with use of increasing amounts of native protein used to prepare the food composition or food ingredient. In this method of preparing a food composition or food ingredient, the amount of the isolated plant protein in the food composition or food ingredient, by weight, is between 10% and 95%, or any range between 10% and 95%. In one embodiment, the amount of the denatured protein, by weight, is between 10% and 95%, or any range between 10% and 95%.

In one embodiment of preparing a food composition or food ingredient, the amount of the isolated plant protein in the food composition or food ingredient, by weight, is between 10% and 95% and any range between 10% and 95%. In one embodiment, the amount of the denatured protein, by weight, is between 10% and 95%, or any range between 10% and 95%.

In one embodiment of preparing a food composition or food ingredient, the isolated plant protein may be isolated from dry beans, lentils, fava beans, dry peas, chickpeas, cowpeas, bambara beans, pigeon peas, lupins, vetches, adzuki, common beans, fenugreek, long beans, lima beans, runner beans, tepary beans, soybeans, or mucuna beans. In any embodiments of the method of controlling the hardness and/or apparent modulus, the isolated plant protein may be isolated from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the isolated plant protein may be isolated from mung beans (Vigna radiata). In other embodiments, the isolated plant protein may be isolated from almonds and other nuts, seeds such as sesame seeds, sunflower seeds, and other commonly consumed nuts, fruits and seeds.

In some embodiments of preparing a food composition or food ingredient, the hardness of the food composition or food ingredient is greater than 200 g, or between 3000 g, or any range between 200 g and 3000 g.

In some embodiments of preparing a food composition or food ingredient, the apparent modulus of the food composition or food ingredient is between 10,000 Pa and 150,000 Pa, or any range between 10,000 Pa and 150,000 Pa.

In an embodiment of preparing a food composition or food ingredient, the isolated plant protein in the food composition or food ingredient are cross-linked by exposure to one or more protein cross-linking enzymes. In one embodiment the amount of cross-linking enzyme of the food composition, food ingredient, isolated protein, or food ingredients is between 0.0001% to 0.5%. After exposure to the cross-linking enzyme for a desired amount of time, the enzyme is inactivated by (HTST), high-temperature, long-time (HTLT) or other known heat exposure methods. In one embodiment, the protein cross-linking enzyme is selected from the group consisting of transglutaminase, sortase, subtilisin, tyrosinase, laccase, peroxidase, glucose oxidase and lysyl oxidase.

In any of the various embodiments herein, the isolated plant protein is an isolated plant protein, the plant protein may have been isolated from dry beans, lentils, fava beans, dry peas, chickpeas, cowpeas, bambara beans, pigeon peas, lupins, vetches, adzuki, common beans, fenugreek, long beans, lima beans, runner beans, tepary beans, soybeans, or mucuna beans. In any of the various embodiments of the isolated pulse protein, the pulse protein may be isolated from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some cases, the pulse protein is isolated from mung beans (Vigna radiata). In other embodiments, the milled composition may comprise almonds and other nuts, seeds such as sesame seeds, sunflower seeds, and other commonly consumed nuts, fruits and seeds.

### BRIEF DESCRIPTION OF THE DRAWINGS

FIG. 1 shows the differential scanning calorimetry thermograms of native and denature mung bean protein isolate

FIG. 2 shows the hardness of a food comprising isolated plant protein.

FIG. 3 shows the apparent modulus of a food comprising isolated plant protein.

FIG. 4 shows the size exclusion HPLC chromatogram of DD26 and Ja291.

FIG. 5 shows the aqueous solubility of DD26 and Ja291.

FIG. 6 shows the size exclusion HPLC chromatogram of native and denatured soybean protein.

FIG. 7 shows the differential scanning calorimetry thermograms of native and denatured soybean protein.

FIG. 8 shows the hardness of a food comprising isolated soybean protein.

FIG. 9 shows the size exclusion HPLC chromatogram of native and denatured chickpea protein.

FIG. 10 shows the differential scanning calorimetry thermograms of native and denatured chickpea protein.

FIG. 11 shows the hardness of a food comprising isolated chickpea protein.

### DETAILED DESCRIPTION

Before the present invention is described, it is to be understood that this invention is not limited to particular methods and experimental conditions described, as such methods and conditions may vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. As used herein, the term “about,” when used in reference to a particular recited numerical value, means that the value may vary from the recited value by no more than 1%. For example, as used herein, the expression “about 100” includes 99 and 101 and all values in between (e.g., 99.1, 99.2, 99.3, 99.4, etc.).

Although any methods and materials similar or equivalent to those described herein can be used in the practice or testing of the present invention, the preferred methods and materials are now described. All patents, applications and non-patent publications mentioned in this specification are incorporated herein by reference in their entireties.

### Definitions

As used herein, the singular forms “a,” “an,” and “the” include the plural referents unless the context clearly indicates otherwise.

The term “reduce” indicates a lessening or decrease of an indicated value relative to a reference value. In some embodiments, the term “reduce” (including “reduction”) refers to a lessening or a decrease of an indicated value by about 5%, 10%, 15%, 20%, 25%, 30%, 35%, 40%, 45%, or 50% relative to a reference value. In some embodiments, the term “reduce” (including “reduction”) refers to a lessening or a decrease of an indicated value by at least about 5%, 10%, 15%, 20%, 25%, 30%, 35%, 40%, 45%, or 50% relative to a reference value.

As used herein, the term “eggs” includes but is not limited to chicken eggs, other bird eggs (such as quail eggs, duck eggs, ostrich eggs, turkey eggs, bantam eggs, goose eggs), and fish eggs such as fish roe. Typical food application comparison is made with respect to chicken eggs.

As used herein, the term “enriched,” “increased” or the like refers to an increase in a percent amount of a molecule, for example, a protein, in one sample relative to the amount of the molecule in a reference sample. The enrichment may be conveniently expressed as a percent enrichment or increase. For example, an isolate enriched in a certain type of globulin protein relative to whole pulses (e.g., mung beans) means that, the amount of the globulin protein in the isolate expressed as a percentage of the amount of total protein in the isolate, is higher than the amount of the globulin protein in a whole pulse (e.g., mung bean) expressed as a percentage of the amount of total protein in the whole pulse. In some embodiments, the enrichment is on a weight-to-weight basis. In some embodiments, the enrichment refers to an increase of about 5%, 10%, 15%, 20%, 25%, 30%, 35%, 40%, 45%, or 50% relative to the reference value or amount. In some embodiments, the enrichment refers to an increase of at least about 5%, 10%, 15%, 20%, 25%, 30%, 35%, 40%, 45%, or 50% relative to the reference value or amount.

As used herein, the term “depleted,” “decreased” or the like refers to a decrease in a percent amount of a molecule, for example, a protein, in one sample relative to the amount of the molecule in a reference sample. The depletion may be conveniently expressed as a percent depletion, decrease or reduction. For example, an isolate decreased in a certain type of globulin protein relative to whole pulses (e.g., mung beans) means that, the amount of the globulin protein in the isolate expressed as a percentage of the amount of total protein in the isolate, is lower than the amount of the globulin protein in a whole pulse (e.g., mung bean) expressed as a percentage of the amount of total protein in the whole pulse. In some embodiments, the depletion is on a weight-to-weight basis. In some embodiments, the depletion refers to a decrease of about 5%, 10%, 15%, 20%, 25%, 30%, 35%, 40%, 45%, or 50% relative to the reference value or amount. In some embodiments, the depletion refers to a decrease of at least about 5%, 10%, 15%, 20%, 25%, 30%, 35%, 40%, 45%, or 50% relative to the reference value or amount.

As used herein, “molecular weight,” “molecular size” or similar expressions refer to the molecular mass of compounds, such as proteins, expressed as Dalton (Da) or kilodalton (kDa). The molecular weight of a compound can be precise or can be an average molecular mass. For example, the molecular weight of a discrete compound, such as NaCl or a specific protein can be precise. For the molecular sizes of protein isolates of the invention, an average molecular mass is typically used. For example, protein isolates obtained in the retentate fraction of a purification process using an ultrafiltration membrane having a molecular weight cut-off of 10 kDa are depleted in proteins (and other compounds) that have an average molecular weight of less 10 kDa. The retentate fraction from a 10 kDa UF membrane can also be described as being enriched in proteins (and other compounds) that have an average molecular weight of greater than 10 kDa. The permeate fraction of a purification process using an ultrafiltration membrane having a molecular weight cut-off of 10 kDa is enriched in proteins (and other compounds) that have an average molecular weight of less than 10 kDa. The permeate fraction from a 10 kDa UF membrane can also be described as being depleted in proteins (and other compounds) that have an average molecular weight of greater than 10 kDa.

As used herein, “plant source of the isolate” refers to a whole plant material such as whole mung bean or other pulse, or from an intermediate material made from the plant, for example, a dehulled bean, a flour, a powder, a meal, ground grains, a cake (such as, for example, a defatted or de-oiled cake), or any other intermediate material suitable to the processing techniques disclosed herein to produce a purified protein isolate.

The term “transglutaminase” refers to an enzyme (R-glutamyl—peptide:amine glutamyl transferase) that catalyzes the acyl-transfer between γ-carboxyamide groups and various primary amines, classified as EC 2.3.2.13. It is used in the food industry to improve texture of some food products such as dairy, meat and cereal products. It can be isolated from a bacterial source, a fungus, a mold, a fish, a mammal and a plant.

The terms “majority” or “predominantly” with respect to a specified component, e.g., protein content, refer to the component having at least 50% by weight of the referenced batch, process stream, food formulation or composition.

Unless indicated otherwise, percentage (%) of ingredients refer to total % by weight typically on a dry weight basis unless otherwise indicated.

The term “purified protein isolate”, “protein isolate”, “isolate”, “protein extract”, “isolated protein” or “isolated polypeptide” refers to a protein fraction, a protein or polypeptide that by virtue of its origin or source of derivation (1) is not associated with naturally associated components that accompany it in its native state, (2) exists in a purity not found in nature, where purity can be adjudged with respect to the presence of other cellular material (e.g., is free of other proteins from the same species) (3) is expressed by a cell from a different species, or (4) does not occur in nature (e.g., it is a fragment of a polypeptide found in nature or it includes amino acid analogs or derivatives not found in nature or linkages other than standard peptide bonds). One or more proteins or fractions may be partially removed or separated from residual source materials and/or non-solid protein materials and, therefore, are non-naturally occurring and are not normally found in nature. A polypeptide or protein may also be rendered substantially free of naturally associated components by isolation, using protein purification techniques known in the art and as described herein. A polypeptide that is chemically synthesized or synthesized in a cellular system different from the cell from which it naturally originates will be “isolated” from its naturally associated components. As thus defined, “isolated” does not necessarily require that the protein, polypeptide, peptide or oligopeptide so described has been physically removed from its native environment.

The term “protein cross-linking enzyme” is an enzyme that produces covalent bonds between amino acids on a protein, polypeptide or peptide. The covalent bonds can be intermolecular bonds or intramolecular bonds.

The term “native” or “undenatured” as used in reference to protein, polypeptide or peptide refers to the maintenance of the quaternary, tertiary or secondary structure of the protein, polypeptide or peptide as present in the native form of the protein, polypeptide or peptide. The three-dimensional structure of the native or undenatured protein, polypeptide or peptide is highly ordered and characterized by many weak molecular interactions, such as hydrogen bonding, hydrophilic interactions and hydrophobic interactions. Native or undenatured proteins maintain some or all the biological functions of the protein, such as enzymatic function or storage function. Techniques used to determine the amounts of native and denatured protein include circular dichroism, size exclusion chromatography, IR spectroscopy; electrophoretic techniques such as PAGE and two dimensional gel electrophoresis; zeta potential determination; calorimetry; and other know methods. In certain embodiments, they are measured by differential scanning calorimetry. In particular embodiments, they are measured according to Example 3 herein.

The term “denatured” as used in reference to protein, polypeptide or peptide refers to loss of the quaternary, tertiary or secondary structure of the protein, polypeptide or peptide as present in the native form of the protein, polypeptide or peptide. The three-dimensional structure of the denatured protein, polypeptide or peptide is disordered and characterized by disruption of the many weak molecular interactions, such as hydrogen bonding, hydrophilic interactions and hydrophobic interactions present in the native form. Most denatured proteins lose their biological function.

The term “hardness” as used in reference to protein, polypeptide or peptide refers to the peak force needed to deform the protein, polypeptide or peptide. Hardness is a force unit, often measured in newtons, or in gram-force. Hardness is be measured by techniques that rely on measuring the force required to deform, indent, compress, flex or apply tension to the material. Food texture analyzers are widely available. In particular embodiments, hardness is measured according to Example 6 herein.

The term “apparent modulus” or “Young's modulus” as used in reference to protein, polypeptide or peptide refers to the slope of a linear portion of a stress vs. strain curve during a compression stroke. The apparent modulus measures the tensile stiffness of a solid material. In the food science arts, the apparent modulus of the food composition is thought of as the perception of “bite” of the food. Young's modulus or the apparent modulus is measured by techniques that rely on measuring the force required to measure deformation, elasticity, brittleness, and other parameters. Instrumentation used to measure Young's modulus are widely available. In particular embodiments, apparent modulus is measured according to Example 4 herein.

The term “an isolated plant protein” as used herein refers to a protein or proteins that are obtained from a plant source, or a combination of proteins that are obtained from a plant source, or a composition thereof.

Isolated Plant Protein Comprising Native and Denatured Proteins

The present disclosure includes isolated plant proteins that comprise both native (undenatured) and denatured protein. The hardness and/or the gel elasticity of the isolated plant protein increases with increased native protein content.

In various embodiments, the isolated plant proteins may be isolated from any plant, including dry beans, lentils, fava beans, dry peas, chickpeas, cowpeas, bambara beans, pigeon peas, lupins, vetches, adzuki, common beans, fenugreek, long beans, lima beans, runner beans, tepary beans, soybeans, or mucuna beans. In various embodiments, the isolated plant proteins may be isolated from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some embodiments, the pulse proteins are isolated from mung beans (Vigna radiata). In other embodiments, the milled composition may comprise almonds and other nuts, seeds such as sesame seeds, sunflower seeds, and other commonly consumed nuts, fruits and seeds.

The isolated plant protein (e.g., mung bean isolates) provided herein may be prepared from any suitable source of plant protein, where the starting material is whole plant material (e.g., whole mung bean). In some cases, the methods may include dehulling the raw source material. In some such embodiments, raw plant protein materials (e.g., mung beans) may be de-hulled in one or more steps of pitting, soaking, and drying to remove the seed coat (husk) and pericarp (bran). The de-hulled material (e.g., mung beans) are then milled to produce a composition (e.g., flour) with a well-defined particle distribution size. The types of mills employed may include one or a combination of a hammer, pin, knife, burr, and air classifying mills.

The isolated plant protein may be isolated by isoelectric precipitation, ultrafiltration or any other method to separate the isolated plant protein from other materials.

It is to be understood that the steps of the methods discussed above or herein may be performed in alternative orders consistent with the objective of producing an isolated plant protein.

The present disclosure provides an isolated plant protein (e.g., mung bean protein isolates, that comprise native and denatured proteins). The isolated plant protein is edible and comprise one or more desirable food qualities, including but limited to, high protein content, high protein purity, reduced retention of small molecular weight non-protein species (including mono and disaccharides), reduced retention of oils and lipids, superior structure building properties such as high gel strength and apparent modulus (gel elasticity), superior sensory properties. The hardness and/or apparent modulus of the isolated plant protein comprising both native and denatured proteins is determined by the relative amounts of native protein and denatured protein. The hardness and/or apparent modulus of the isolated plant protein increases with increasing amounts of native protein.

In various embodiments, isolated plant protein provided herein is derived from dry beans, lentils, fava beans, dry peas, chickpeas, cowpeas, bambara beans, pigeon peas, lupins, vetches, adzuki, common beans, fenugreek, long beans, lima beans, runner beans, or tepary beans, soybeans, or mucuna beans. In various embodiments, the pulse protein isolates provided herein are derived from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some embodiments, the pulse protein isolates are derived from mung beans. In some embodiments, the mung bean is Vigna radiata. In other embodiments, the isolated plant protein may be obtained from almonds and other nuts, seeds such as sesame seeds, sunflower seeds, and other commonly consumed nuts, fruits and seeds. In various embodiments, the isolated plant protein (e.g., mung bean protein isolate) discussed herein can be produced from any source of plant protein (e.g., mung bean protein, including any varietal or cultivar of V. radiata). For example, the protein isolate can be prepared directly from whole plant material such as whole mung bean, or from an intermediate material made from the plant, for example, a dehulled bean, a flour, an air classified flour, a powder, a meal, ground grains, a cake (such as, for example, a defatted or de-oiled cake), or any other intermediate material suitable to the processing techniques disclosed herein to produce an isolated plant protein. In some embodiments, the source of the plant protein may be a mixture of two or more intermediate materials. The examples of intermediate materials provided herein are not intended to be limiting.

### Characteristics of the Isolated Plant Protein

In various embodiments, the isolated plant protein (e.g., mung bean protein isolate) comprises native proteins and denatured proteins. In one embodiment, the amount of the native protein, by weight, of the plant protein isolate is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%. In one embodiment, the amount of the denatured protein, by weight, of the plant protein isolate is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

In an embodiment, the isolated plant protein is a globulin-type protein. In an embodiment, the isolated plant protein is a storage protein. The storage proteins can be identified by their sedimentation coefficients. The sedimentation coefficients of pulse proteins are typically 7S, 8S, 115, 12S and 13S. The primary storage proteins of mung beans are 8S and 115. The primary storage proteins of soybeans are 7S and 115. The primary storage proteins of pea are 7S and 115.

In some embodiments, the hardness of the isolated plant protein is greater than 3 N; 5 N; 6 N; 7 N; 8 N; 9 N; 10 N; 11 N; 12 N; 13 N; 14 N; 15 N; 16 N; 17 N; 18 N; 19 N; or 20 N. In other embodiments, the hardness of the plant protein is between 3 N-18 N; 3 N-17 N; 3 N-16 N; 3 N-15 N; 3 N-14 N; 3 N-13 N; 3 N-12 N; 3 N-11 N; 3 N-10 N; 3 N-9 N; 3 N-8 N; 3 N-7 N; 3 N-6 N; 3 N-5 N; 3 N-4 N; 4 N-10 N; 4 N-9 N; 4 N-7 N; 4 N-6 N; or 4 N-5 N.

In some embodiments, the apparent modulus of the isolated plant protein is greater than 10,000 Pa; 20,000 Pa; 30,000 Pa; 40,000 Pa; 50,000 Pa; 60,000 Pa; 70,000 Pa; 80,000 Pa; 90,000 Pa; 100,000 Pa; 110,000 Pa; 120,000 Pa; or 130,000 Pa. In other embodiments, the apparent modulus of the plant protein is between 10,000 Pa-130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

In some embodiments, the isolated plant protein (e.g., mung bean protein isolate) is cross linked by contacting the isolated plant protein with a protein cross-linking enzyme. In an embodiment the protein cross-linking enzyme or a protein cross-linking agent is selected from transglutaminase, sortase, subtilisin, tyrosinase, laccase, peroxidase, glucose oxidase or lysyl oxidase. In some embodiments the isolated plant protein is cross-linked by contacting the isolated plant protein with a non-enzymatic protein cross-linking agent. Non-enzymatic protein cross-linking agents use the side chains of amino acids to form covalent linkages. In an embodiment of cross-linking the isolated plant protein, the amount of cross-linking enzyme is between 0.0001% to 0.5%; between 0.0001% to 0.4%; between 0.0001% to 0.4%; between 0.0001% to 0.3%; between 0.0001% to 0.2%; between 0.0001% to 0.1%; between 0.0001% to 0.09%; between 0.0001% to 0.08%; between 0.0001% to 0.07%; between 0.00% to 0.06%; between 0.0001% to 0.05%; between 0.0001% to 0.04%; between 0.0001% to 0.03%; between 0.0001% to 0.01%; between 0.001% to 0.1%; between 0.001% to 0.09%; between 0.001% to 0.08%; between 0.001% to 0.07%; between 0.001% to 0.06%; between 0.001% to 0.05%; between 0.001% to 0.04%; between 0.001% to 0.03%; between 0.001% to 0.02%; between 0.001% to 0.01%; between 0.01% to 0.09%; between 0.01% to 0.08%; between 0.01% to 0.07%; between 0.01% to 0.06%; between 0.01% to 0.05%; between 0.001% to 0.04%; between 0.01% to 0.03%; or between 0.01% to 0.02%. The cross-linking enzyme is exposed to the food composition or food ingredient for a period of between 1 second and 120 minutes; between 1 second and 110 minutes; between 1 second and 100 minutes; between 1 second and 90 minutes; between 1 second and 80 minutes; between 1 second and 70 minutes; between 1 second and 60 minutes; between 1 second and 50 minutes; between 1 second and 40 minutes; between 1 second and 30 minutes; 1 between second and 10 minutes; between 1 second and 9 minutes; between 1 second and 8 minutes; between 1 second and 7 minutes; between 1 second and 6 minutes; between 1 second and 5 minutes; between 1 second and 4 minutes; between 1 second and 3 minutes; between 1 second and 2 minutes; between 1 second and 1 minute; between 1 second and 50 second; between 1 second and 40 seconds; between 1 second and 30 seconds; between 1 second and 20 seconds; between 1 second and 10 seconds; between 1 second and 5 seconds; After exposure to the cross-linking enzyme for a desired amount of time, the enzyme is inactivated by exposure to heat or other known methods of inactivating enzymes. In one embodiment, cross-linking enzyme is inactivated by exposure to high-temperature, short-time (HTST), high-temperature, long-time or other known heat exposure methods. In one embodiment, the inactivation of the cross-linking enzyme is accomplished by exposure to temperatures of between 40° C. to 100° C.; between 40° C. to 95° C.; between 40° C. to 90° C.; between 40° C. to 85° C.; between 40° C. to 80° C.; between 40° C. to 70° C.; between 40° C. to 65° C.; between 40° C. to 60° C.; between 40° C. to 55° C.; between 40° C. to 50° C.; between 40° C. to 45° C.; between 50° C. to 100° C.; between 50° C. to 95° C.; between 50° C. to 90° C.; between 50° C. to 80° C.; between 50° C. to 75° C.; between 50° C. to 70° C.; between 50° C. to 65° C.; between 50° C. to 60° C.; between 50° C. to 55° C.; between 60° C. to 100° C.; between 60° C. to 95° C.; between 60° C. to 90° C.; between 60° C. to 85° C.; between 60° C. to 80° C.; between 60° C. to 75° C.; between 70° C. to 70° C.; between 60° C. to 75° C.; between 60° C. to 70° C.; between 60° C. to 65° C.; between 70° C. to 100° C.; between 70° C. to 95 C; between 70° C. to 90° C.; between 70° C. to 85° C.; between 70° C. to 80° C.; or between 70° C. to 75° C.

In some embodiments, the isolated plant protein (e.g., mung bean protein isolate) comprises about 1% to 10%, 2% to 9%, 3% to 8%, or 4% to 6% of fats derived from the plant source of the isolate. In some embodiments, the isolated plant protein comprises less than about 10%, 9%, 8%, 7%, 6% or 5% of fats derived from the plant source of the isolate. In some embodiments, the isolated plant protein comprises about 9%, 8%, 7%, 6%, 5%, 4%, 3%, 2%, or about 1% of fats derived from the plant source of the isolate.

In some embodiments, the isolated plant protein (e.g., mung bean protein isolate) comprises about 1% to 10% of moisture derived from the plant source of the isolate. In some embodiments, the isolated plant protein comprises less than about 10%, 9%, 8%, 7%, 6% or 5% of moisture derived from the plant source of the isolate. In some embodiments, the isolated plant protein comprises about 9%, 8%, 7%, 6%, 5%, 4%, 3%, 2%, or about 1% of moisture derived from the plant source of the isolate.

In various embodiments, the isolated plant protein may have a moisture content ranging from 5% to 90% or more. In some cases, the moisture content is 5% to 50%. In some cases, the moisture content is from 50% to 90%. In various embodiments, the moisture content is 10%, 20%, 30%, 40%, 50%, 60%, 70%, 80% or 90%.

### Reduced Allergen, Anti-Nutritional, and Environmental Contaminant Content

In some embodiments, the isolated plant protein (e.g., mung bean protein isolate) provided herein has a reduced allergen content. In some embodiments, the reduced allergen content is relative to the allergen content of the plant source of the isolate. The isolated plant protein or a composition comprising the isolated plant protein may be animal-free, dairy-free, soy-free and gluten-free. Adverse immune responses such as hives or rash, swelling, wheezing, stomach pain, cramps, diarrhea, vomiting, dizziness and even anaphylaxis presented in subjects who are typically allergic to eggs may be averted. Further, the isolated plant protein or a composition comprising the isolated plant protein may not trigger allergic reactions in subjects based on milk, eggs, soy and wheat allergens. Accordingly, in some embodiments, the isolated plant protein or a composition comprising the isolated plant protein is substantially free of allergens.

Dietary anti-nutritional factors are chemical substances that can adversely impact the digestibility of protein, bioavailability of amino acids and protein quality of foods (Gilani et al., 2012). In some embodiments, the isolated plant protein (e.g., mung bean protein isolates) provided herein has reduced amounts of anti-nutritional factors. In some embodiments, the reduced amount of anti-nutritional factors is relative to the content of the plant source of the isolate. In some embodiments, the reduced anti-nutritional factor is selected from the group consisting of tannins, phytic acid, hemagglutinins (lectins), polyphenols, trypsin inhibitors, α-amylase inhibitors, lectins and protease inhibitors.

In various embodiments, environmental contaminants are either free from the isolated plant protein (e.g., mung bean protein isolates), below the level of detection of 0.1 ppm, or present at levels that pose no toxicological significance. In some embodiments, the reduced environmental contaminant is a pesticide residue. In some embodiments, the pesticide residue is selected from the group consisting of: chlorinated pesticides, including alachlor, aldrin, alpha-BHC, alpha-chlordane, beta-BHC, DDD, DDE, DDT, delta-BHC, dieldrin, endosulfan I, endosulfan II, endosulfan sulfate, endrin, endrin aldehyde, gamma-BHC, gamma-chlordane, heptachlor, heptachlor epoxide, methoxyclor, and permethrin; and organophosphate pesticides including azinophos methyl, carbophenothion, chlorfenvinphos, chlorpyrifos methyl, diazinon, dichlorvos, dursban, dyfonate, ethion, fenitrothion, malathion, methidathion, methyl parathion, parathion, phosalone, and pirimiphos methyl. In some embodiments, the reduced environmental contaminant is selected from residues of dioxins and polychlorinated biphenyls (PCBs), or mycotoxins such as aflatoxin B1, B2, G1, G2, and ochratoxin A.

### Other Food Functionality Characteristics of the Isolated Plant Protein

The isolated plant protein comprising native and denatured proteins as discussed herein may also have one or more functional properties alone or when incorporated into a food composition. Such functional properties may include, but are not limited to, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments, at least one functional property of the isolated plant protein differs from the corresponding functional property of the source of the plant protein. In some embodiments, at least one functional property of the isolated plant protein (alone or when incorporated into a food composition) is similar or equivalent to the corresponding functional property of a reference food product, such as, for example, an egg (liquid, scrambled, or in patty form), a cake (e.g., pound cake, yellow cake, or angel food cake), a cream cheese, a pasta, an emulsion, a confection, an ice cream, a custard, milk, a deli meat, chicken (e.g., chicken nuggets), or a coating. In some embodiments, the isolated plant protein, either alone or when incorporated into a composition, is capable of forming a gel under heat or at room temperature.

### Food Composition or Food Ingredient

The present disclosure provides a food composition or a food ingredient comprising an isolated plant protein (e.g., mung bean protein isolates). The isolated plant protein comprises native and denatured proteins. The isolated plant protein is edible and comprises one or more desirable food qualities, including but limited to, high protein content, high protein purity, reduced retention of small molecular weight non-protein species (including mono and disaccharides), reduced retention of oils and lipids, superior structure building properties such as high gel strength and apparent modulus (gel elasticity), superior sensory properties. The hardness and/or apparent modulus of the food composition or a food ingredient comprising isolated plant protein is determined by the relative amounts of native protein and denatured protein present in the isolated plant protein. The hardness and/or apparent modulus of the food composition or a food ingredient increases with increasing amounts of native protein as provided in the isolated plant protein.

In various embodiments of the food composition or a food ingredient that contains the isolated plant protein, the isolated plant protein (e.g., mung bean protein isolate) comprises native proteins and denatured proteins. In one embodiment, the amount of the native protein, by weight, of the isolated plant protein is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%. In one embodiment, the amount of the denatured protein, by weight, of the isolated plant protein is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

In an embodiment of a food composition or food ingredient comprising isolated plant protein, the isolated plant protein is a globulin-type protein. In an embodiment of a food composition or food ingredient comprising isolated plant protein, the globulin-type protein is selected from the group consisting of 7S, 8S and 11S.

In some embodiments, the hardness of the food composition or a food ingredient comprising isolated plant protein is greater than 3 N; 5 N; 6 N; 7 N; 8 N; 9 N; 10 N; 11 N; 12 N; 13 N; 14 N; 15 N; 16 N; 17 N; 18 N; 19 N; or 20 N. In other embodiments, the hardness of the food composition or a food ingredient comprising isolated plant protein is between 3 N-18 N; 3 N-17 N; 3 N-16 N; 3 N-15 N; 3 N-14 N; 3 N-13 N; 3 N-12 N; 3 N-11 N; 3 N-10 N; 3 N-9 N; 3 N-8 N; 3 N-7 N; 3 N-6 N; 3 N-5 N; 3 N-4 N; 4 N-10 N; 4 N-9 N; 4 N-7 N; 4 N-6 N; or 4 N-5 N.

In some embodiments, the apparent modulus of the food composition or a food ingredient comprising isolated plant protein is greater than 10,000 Pa; 20,000 Pa; 30,000 Pa; 40,000 Pa; 50,000 Pa; 60,000 Pa; 70,000 Pa; 80,000 Pa; 90,000 Pa; 100,000 Pa; 110,000 Pa; 120,000 Pa; or 130,000 Pa. In other embodiments, the apparent modulus of the food composition or a food ingredient comprising isolated plant protein is between 10,000 Pa-130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

In some embodiments of the food composition or food ingredient, the isolated plant protein (e.g., mung bean protein isolate) is cross-linked by contacting the plant protein with a protein cross-linking enzyme. In an embodiment of the food composition or a food ingredient, the protein cross-linking enzyme or a protein cross-linking agent is selected from transglutaminase, sortase, subtilisin, tyrosinase, laccase, peroxidase, glucose oxidase or lysyl oxidase. In some embodiments of the food composition or a food ingredient, the plant protein is cross-linked by contacting the plant protein with a non-enzymatic protein cross-linking agent. Non-enzymatic protein cross-linking agents use the side chains of amino acids to form covalent linkages. In an embodiment of the food compositions or food ingredient, the amount of cross-linking enzyme is between 0.0001% to 0.5%; between 0.0001% to 0.4%; between 0.0001% to 0.4%; between 0.0001% to 0.3%; between 0.0001% to 0.2%; between 0.0001% to 0.1%; between 0.0001% to 0.09%; between 0.0001% to 0.08%; between 0.0001% to 0.07%; between 0.00% to 0.06%; between 0.0001% to 0.05%; between 0.0001% to 0.04%; between 0.0001% to 0.03%; between 0.0001% to 0.01%; between 0.001% to 0.1%; between 0.001% to 0.09%; between 0.001% to 0.08%; between 0.001% to 0.07%; between 0.001% to 0.06%; between 0.001% to 0.05%; between 0.001% to 0.04%; between 0.001% to 0.03%; between 0.001% to 0.02%; between 0.001% to 0.01%; between 0.01% to 0.09%; between 0.01% to 0.08%; between 0.01% to 0.07%; between 0.01% to 0.06%; between 0.01% to 0.05%; between 0.001% to 0.04%; between 0.01% to 0.03%; or between 0.01% to 0.02%. The cross-linking enzyme is exposed to the food composition or food ingredient for a period of between 1 second and 120 minutes; between 1 second and 110 minutes; between 1 second and 100 minutes; between 1 second and 90 minutes; between 1 second and 80 minutes; between 1 second and 70 minutes; between 1 second and 60 minutes; between 1 second and 50 minutes; between 1 second and 40 minutes; between 1 second and 30 minutes; 1 between second and 10 minutes; between 1 second and 9 minutes; between 1 second and 8 minutes; between 1 second and 7 minutes; between 1 second and 6 minutes; between 1 second and 5 minutes; between 1 second and 4 minutes; between 1 second and 3 minutes; between 1 second and 2 minutes; between 1 second and 1 minute; between 1 second and 50 second; between 1 second and 40 seconds; between 1 second and 30 seconds; between 1 second and 20 seconds; between 1 second and 10 seconds; between 1 second and 5 seconds; After exposure to the cross-linking enzyme for a desired amount of time, the enzyme is inactivated by exposure to heat or other known methods of inactivating enzymes. In one embodiment, cross-linking enzyme is inactivated by exposure to high-temperature, short-time (HTST), high-temperature, long-time or other known heat exposure methods. In one embodiment, the inactivation of the cross-linking enzyme is accomplished by exposure to temperatures of between 40° C. to 100° C.; between 40° C. to 95° C.; between 40° C. to 90° C.; between 40° C. to 85° C.; between 40° C. to 80° C.; between 40° C. to 70° C.; between 40° C. to 65° C.; between 40° C. to 60° C.; between 40° C. to 55° C.; between 40° C. to 50° C.; between 40° C. to 45° C.; between 50° C. to 100° C.; between 50° C. to 95° C.; between 50° C. to 90° C.; between 50° C. to 80° C.; between 50° C. to 75° C.; between 50° C. to 70° C.; between 50° C. to 65° C.; between 50° C. to 60° C.; between 50° C. to 55° C.; between 60° C. to 100° C.; between 60° C. to 95° C.; between 60° C. to 90° C.; between 60° C. to 85° C.; between 60° C. to 80° C.; between 60° C. to 75° C.; between 70° C. to 70° C.; between 60° C. to 75° C.; between 60° C. to 70° C.; between 60° C. to 65° C.; between 70° C. to 100° C.; between 70° C. to 95 C; between 70° C. to 90° C.; between 70° C. to 85° C.; between 70° C. to 80° C.; or between 70° C. to 75° C.

The isolated plant protein comprising native and denatured proteins (e.g., mung bean protein isolates) discussed herein may be incorporated into a food composition along with one or more other edible ingredients. In some cases, the isolated plant protein may be used as a direct protein replacement of animal- or vegetable-based protein in a variety of conventional food and beverage products across multiple categories. In some embodiments, the use levels range from 3 to 90% w/w of the final product. Exemplary food compositions in which the isolated plant protein can be used are discussed below. In some embodiments, the isolated plant protein is used as a supplement to existing protein in food products. In any of the various embodiments of the food compositions, the isolated plant protein may be contacted with a cross-linking enzyme to cross-link the plant proteins. In various embodiments, the cross-linking enzyme is selected from transglutaminase, sortase, subtilisin, tyrosinase, laccase, peroxidase, glucose oxidase or lysyl oxidase. In some embodiments, the cross-linking enzyme is transglutaminase. In any of the various embodiments of the food compositions, the isolated plant protein may be contacted with a protein modifying enzyme such as papain, pepsin, rennet, coagulating enzymes or sulfhydryl oxidase to modify the structure of the plant proteins.

The isolated plant protein provided herein are suitable for various food applications and can be incorporated into, e.g., edible egg-free emulsion, egg analog, egg-free scrambled eggs, egg-free patty, egg-free pound cake, egg-free angel food cake, egg-free yellow cake, egg-free cream cheese, egg-free pasta dough, egg-free custard, egg-free ice cream, and dairy-free milk. The isolated plant protein can also be used as replacement ingredients in various food applications including but not limited to meat substitutes, egg substitutes, baked goods and fortified drinks

In various embodiments, one or more isolated plant protein can be incorporated into multiple food compositions, including liquid and patty scrambled egg substitutes to a desired level of emulsification, water binding and gelation. In an embodiment, a functional egg replacement product comprises isolated plant protein (8-15%), and one or more of: oil (10%), hydrocolloid, preservative, and optionally flavors, water, lecithin, xanthan, sodium carbonate, and black salt.

In some embodiments, the isolated plant protein is incorporated in an egg substitute composition. In some such embodiments, the organoleptic property of the isolated plant protein (e.g., a flavor or an aroma) is similar or equivalent to a corresponding organoleptic property of an egg. The egg substitute composition may exhibit at least one functional property (e.g., emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color) that is similar or equivalent to a corresponding functional property of an egg. In addition to the isolated plant protein, the egg substitute composition may include one or more of iota-carrageenan, gum arabic, konjac, xanthan gum, or gellan.

In some embodiments, the isolated plant protein is incorporated in an egg-free cake, such as a pound cake, a yellow cake, or an angel food cake. In some such embodiments, at least one organoleptic property (e.g., a flavor or an aroma) of the egg-free cake is similar or equivalent to a corresponding organoleptic property of a cake containing eggs. The egg-free cake may exhibit at least one functional property similar or equivalent to a corresponding functional property of a cake containing eggs. The at least one function property may be, for example, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments in which the isolated plant protein is included in an egg-free pound cake, a peak height of the egg-free pound cake is at least 90% of the peak height of a pound cake containing eggs.

In some embodiments, the isolated plant protein is incorporated into an egg-free cake mix or an egg-free cake batter. In some such embodiments, the egg-free cake mix or batter has at least one organoleptic property (e.g., a flavor or aroma) that is similar or equivalent to a corresponding organoleptic property of a cake mix or batter containing eggs. The egg-free cake mix or batter may exhibit at least one functional property similar or equivalent to a corresponding functional property of a cake batter containing eggs. The at least one functional property may be, for example, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments in which the isolated plant protein is included in an egg-free pound cake batter, a specific gravity of the egg-free pound cake batter is 0.95-0.99.

In some cases, increased functionality is associated with the isolated plant protein in a food composition. For instance, food products produced with the isolated plant protein discussed herein may exhibit increased functionality in dome or crack, cake resilience, cake cohesiveness, cake springiness, cake peak height, specific gravity of batter, center doming, center crack, browning, mouthfeel, spring-back, off flavors or flavor.

In some embodiments, the isolated plant protein is included in a cream cheese, a pasta dough, a pasta, a milk, a custard, a frozen dessert (e.g., a frozen dessert comprising ice cream), a deli meat, or chicken (e.g., chicken nuggets).

In some embodiments, the isolated plant protein is incorporated into a food or beverage composition, such as, for example, an egg substitute, a cake (e.g., a pound cake, a yellow cake, or an angel food cake), a cake batter, a cake mix, a cream cheese, a pasta dough, a pasta, a custard, an ice cream, a milk, a deli meat, or a confection. The food or beverage composition may provide sensory impressions similar or equivalent to the texture and mouthfeel that replicates a reference food or beverage composition. In some embodiments, before being included in a food or beverage composition, the isolated plant protein is further processed in a manner that depends on a target application for the isolated plant protein. For example, the isolated plant protein may be diluted in a buffer to adjust the pH to a pH appropriate for the target application. As another example, the isolated plant protein may be concentrated for use in the target application. As yet another example, the isolated plant protein may be dried for use in the target application. Various examples of food compositions comprising the isolated plant protein are discussed herein provided below.

### Scrambled Egg Analog Using Transglutaminase

In some embodiments, the isolated plant proteins are incorporated into a scrambled egg analog in which the plant isolate (e.g., mung bean protein isolate) has been contacted with transglutaminase (or other cross-linking enzyme) to provide advantageous textural, functional and organoleptic properties. Food processing methods employing transglutaminases are known in the art.

In some embodiments, the transglutaminase is microencapsulated when utilized in the egg analogs provided herein. Microencapsulation of transglutaminase enzyme in such egg mimetic emulsions maintains a stable emulsion by preventing contact of the protein substrate with the transglutaminase enzyme. A cross-linking reaction is initiated upon heating to melt the microencapsulating composition. In some embodiments, the transglutaminase is immobilized on inert porous beads or polymer sheets, and contacted with the egg mimetic emulsions.

In certain aspects of the invention, the method for producing an egg substitute composition comprises contacting an isolated plant protein with an amount of transglutaminase, preferably between 0.0001% to 0.1%. In some embodiments, the method provides an amount of transglutaminase between 0.001% and 0.05%. In some embodiments, the method provides an amount of transglutaminase between 0.001% and 0.0125%.

In various embodiments, the scrambled egg analog comprises an isolated plant protein described herein, along with one or more of the following components: water, disodium phosphate and oil. In some embodiments, the scrambled egg analog further comprises NaCl. In some embodiments, the scrambled egg analog has been contacted with transglutaminase. In a particular embodiment, the scrambled egg analog comprises: Protein Solids: 11.3 g, Water: 81.79 g, Disodium phosphate: 0.4 g, Oil: 6.2 g, NaCl: 0.31 g (based on total weight of 100 g) wherein the protein solids are contacted with between 0.001% and 0.0125% of transglutaminase.

In some embodiments, the composition lacks lipoxygenase.

### Vegan Patty

The isolated plant protein (e.g., mung bean protein isolates) can be used as the sole gelling agent in a formulated vegan patty. In some embodiments, a hydrocolloid system comprised of iota-carrageenan and gum arabic enhances native gelling properties of the isolated plant protein in a formulated patty. In other embodiments, a hydrocolloid system comprised of high-acyl and low-acyl gellan in a 1.5:1 ratio enhances native gelling properties of the isolated plant protein in a formulated patty. In further embodiments, a hydrocolloid system comprised of konjac and xanthan gum enhances native gelling properties of the isolated plant protein in a formulated patty.

### Egg-Free Emulsion

In another embodiment, the isolated plant protein (e.g., mung bean protein isolates) is included in an edible egg-free emulsion. In some embodiments, the emulsion comprises one or more additional components selected from water, oil, fat, hydrocolloid, and starch. In some embodiments, at least or about 60-85% of the edible egg-free emulsion is water. In some embodiments, at least or about 10-20% of the edible egg-free emulsion is the isolated plant protein. In some embodiments, at least or about 5-15% of the edible egg-free emulsion is oil or fat. In some embodiments, at least or about 0.01-6% of the edible egg-free emulsion is the hydrocolloid fraction or starch. In some embodiments, the hydrocolloid fraction comprises high-acyl gellan gum, low-acyl gellan gum, iota-carrageenan, gum arabic, konjac, locust bean gum, guar gum, xanthan gum, or a combination of one or more gums thereof. In some embodiments, the emulsion further comprises one or more of: a flavoring, a coloring agent, an antimicrobial, a leavening agent, and salt. In some embodiments, the emulsion further comprises phosphate.

In an embodiment, the edible egg-free emulsion has a pH of about 5.6 to 6.8. In some cases, the edible egg-free emulsion comprises water, an isolated plant protein as described herein, an enzyme that modifies a structure of the protein isolate, and oil or fat. In some embodiments, the enzyme comprises a transglutaminase or proteolytic enzyme. In some embodiments, at least or about 70-85% of the edible egg-free emulsion is water. In some embodiments, at least or about 7-15% of the edible egg-free emulsion is the isolated plant protein. In some embodiments, at least or about 0.0005-0.0025% (5-25 parts per million) of the edible egg-free emulsion is the enzyme that modifies the structure of the isolated plant protein. In some embodiments, at least or about 5-15% of the edible egg-free emulsion is oil or fat.

### Baked Cake Mixes and Batters

In another embodiment, isolated plant protein (e.g., mung bean protein isolates) is included in one or more egg-free cake mixes, suitable for preparing one or more egg-free cake batters, from which one or more egg-free cakes can be made. In some embodiments, the egg-free cake mix comprises flour, sugar, and an isolated plant protein. In some embodiments, the egg-free cake mix further comprises one or more additional components selected from: cream of tartar, disodium phosphate, baking soda, and a pH stabilizing agent. In some embodiments, the flour comprises cake flour.

In another embodiment, isolated plant protein (e.g., mung bean protein isolates) is included in an egg-free cake batter comprising an egg-free cake mix described above, and water. In some embodiments, the egg-free cake batter is an egg-free pound cake batter, an egg-free angel food cake batter, or an egg-free yellow cake batter. In some embodiments, the egg-free cake batter has a specific gravity of 0.95-0.99.

In an embodiment, an egg-free pound cake mix comprises flour, sugar, and an isolated plant protein. In some embodiments, the flour comprises cake flour. In some embodiments, the egg-free pound cake mix further comprises oil or fat. In some embodiments, the oil or fat comprises butter or shortening. In some embodiments, at least or about 25-31% of the egg-free pound cake batter is flour. In some embodiments, at least or about 25-31% of the egg-free pound cake batter is oil or fat. In some embodiments, at least or about 25-31% of the egg-free pound cake batter is sugar. In some embodiments, at least or about 6-12% of the egg-free pound cake batter is the isolated plant protein. In some embodiments, the batter further comprises disodium phosphate or baking soda.

In an embodiment, an egg-free pound cake batter comprises an egg-free pound cake mix described above, and further comprises water. In some embodiments, the egg-free pound cake batter comprises about four parts of the egg-free pound cake mix; and about one part water. In some embodiments, at least or about 20-25% of the egg-free pound cake batter is flour. In some embodiments, at least or about 20-25% of the egg-free pound cake batter is oil or fat. In some embodiments, at least or about 20-25% of the egg-free pound cake batter is sugar. In some embodiments, at least or about 5-8% of the egg-free pound cake batter is the isolated plant protein. In some embodiments, at least or about 18-20% of the egg-free pound cake batter is water.

In an embodiment, an egg-free angel food cake mix comprises flour, sugar, and an isolated plant protein. In some embodiments, at least or about 8-16% of the egg-free angel food cake mix is flour. In some embodiments, at least or about 29-42% of the egg-free angel food cake mix is sugar. In some embodiments, at least or about 7-10% of the egg-free angel food cake mix is the isolated plant protein. In some embodiments, the egg-free angel food cake mix further comprises cream of tartar, disodium phosphate, baking soda, or a pH stabilizing agent. In some embodiments, the flour comprises cake flour. Also provided herein is an egg-free angel food cake batter comprising an egg-free angel food cake mix described above, and water.

In an embodiment, an egg-free yellow cake mix comprises flour, sugar, and an isolated plant protein. In some embodiments, at least or about 20-33% of the egg-free yellow cake mix is flour. In some embodiments, at least or about 19-39% of the egg-free yellow cake mix is sugar. In some embodiments, at least or about 4-7% of the egg-free yellow cake mix is the isolated plant protein. In some embodiments, the egg-free yellow cake mix further comprises one or more of baking powder, salt, dry milk, and shortening. Also provided herein is an egg-free yellow cake batter comprising an egg-free yellow cake mix described above, and water.

Sensory quality parameters of cakes made with the isolated plant protein are characterized as fluffy, soft, airy texture. The peak height is measured to be 90-110% of pound cake containing eggs. The specific gravity of cake batter with the purified isolated plant protein is 0.95-0.99, similar to that of cake batter with whole eggs of 0.95-0.96.

### Cream Cheese Analog

In another embodiment, isolated plant protein (e.g., mung bean protein isolates) are included in an egg-free cream cheese. In some embodiments, the egg-free cream cheese comprises one or more additional components selected from water, oil or fat, and hydrocolloid. In some embodiments, at least or about 75-85% of the egg-free cream cheese is water. In some embodiments, at least or about 10-15% of the egg-free cream cheese is the isolated plant protein. In some embodiments, at least or about 5-10% of the egg-free cream cheese is oil or fat. In some embodiments, at least or about 0.1-3% of the egg-free cream cheese is hydrocolloid. In some embodiments, the hydrocolloid comprises xanthan gum or a low-methoxy pectin and calcium chloride system. In some embodiments, the egg-free cream cheese further comprises a flavoring or salt. In some embodiments, one or more characteristics of the egg-free cream cheese is similar or equivalent to one or more corresponding characteristics of a cream cheese containing eggs. In some embodiments, the characteristic is a taste, a viscosity, a creaminess, a consistency, a smell, a spreadability, a color, a thermal stability, or a melting property. In some embodiments, the characteristic comprises a functional property or an organoleptic property. In some embodiments, the functional property comprises: emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments, the organoleptic property comprises a flavor or an odor.

### Egg-Free Pasta Dough

In another embodiment, isolated plant protein (e.g., mung bean protein isolates) is included in an egg-free pasta dough. In some embodiments, the egg-free pasta dough comprises one or more additional components selected from flour, oil or fat, and water. In some embodiments, the flour comprises semolina flour. In some embodiments, the oil or fat comprises extra virgin oil. In some embodiments, the egg-free pasta dough further comprises salt. Also provided herein is an egg-free pasta made from an egg-free pasta dough described above. In some embodiments, the egg-free pasta is fresh. In some embodiments, the egg-free pasta is dried. In some embodiments, one or more characteristics of the egg-free pasta is similar or equivalent to one or more corresponding characteristics of a pasta containing eggs. In some embodiments, the one or more characteristics comprise chewiness, density, taste, cooking time, shelf life, cohesiveness, or stickiness. In some embodiments, the one or more characteristics comprise a functional property or an organoleptic property. In some embodiments, the functional property comprises: emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, sheen addition, shine addition, freeze stability, thaw stability, or color. In some embodiments, the organoleptic property comprises a flavor or an odor.

### Plant-Based Milk

In another embodiment, isolated plant protein (e.g., mung bean protein isolates) is included in a plant-based milk. In some embodiments, the plant-based milk comprises one or more additional components selected from water, oil or fat, and sugar. In some embodiments, at least or about 5% of the plant-based milk is the isolated plant protein. In some embodiments, at least or about 70% of the plant-based milk is water. In some embodiments, at least or about 2% of the plant-based milk is oil or fat. In some embodiments, the plant-based milk further comprises one or more of: disodium phosphate, soy lecithin, and trace minerals. In particular embodiments, the plant-based milk is lactose-free. In other particular embodiments, the plant-based milk does not comprise gums or stabilizers.

### Egg-Free Custard

In another embodiment, isolated plant protein (e.g., mung bean protein isolates) is included in an egg-free custard. In some embodiments, the egg-free custard comprises one or more additional components selected from cream and sugar. In some embodiments, at least or about 5% of the egg-free custard is the isolated plant protein. In some embodiments, at least or about 81% of the egg-free custard is cream. In some embodiments, at least or about 13% of the egg-free custard is sugar. In some embodiments, the egg-free custard further comprises one or more of: iota-carrageenan, kappa-carrageenan, vanilla, and salt. In some embodiments, the cream is heavy cream.

### Egg-Free Ice Cream

In another embodiment, isolated plant protein (e.g., mung bean protein isolates) is included in an egg-free ice cream. In some embodiments, the egg-free ice cream is a soft-serve ice cream or a regular ice cream. In some embodiments, the egg-free ice cream comprises one or more additional components selected from cream, milk, and sugar. In some embodiments, at least or about 5% of the egg-free ice cream is the protein isolate. In some embodiments, at least or about 41% of the egg-free ice cream is cream. In some embodiments, at least or about 40% of the egg-free ice cream is milk. In some embodiments, at least or about 13% of the egg-free ice cream is sugar. In some embodiments, the egg-free ice cream further comprises one or more of iota carrageenan, kappa carrageenan, vanilla, and salt. In some embodiments, the cream is heavy cream. In some embodiments, the milk is whole milk. In particular embodiments, the egg-free ice cream is lactose-free. In some embodiments, the egg-free ice cream does not comprise gums or stabilizers. In some embodiments, the egg-free ice provides a traditional mouthfeel and texture of an egg-based ice cream but melts at a slower rate relative to an egg-based ice cream.

### Fat Reduction Shortening System (FRSS)

In another embodiment, isolated plant protein (e.g., mung bean protein isolates) is included in a fat reduction shortening system. In some embodiments, the FRSS comprises one or more additional components selected from water, oil or fat. In some embodiments, the FRSS further comprises sodium citrate. In further some embodiments, the FRSS further comprises citrus fiber. In some embodiments, at least or about 5% of the FRSS is the isolated plant protein. In preferred embodiments, the plant protein based FRSS enables a reduction in fat content in a food application (e.g., a baking application) utilizing the FRSS, when compared to the same food application utilizing an animal and/or dairy based shortening. In some embodiments, the reduction in fat is at least 10%, 20%, 30% or 40% when compared to the same food application utilizing an animal and/or dairy based shortening.

### Meat Analogues

In another embodiment, isolated plant protein (e.g., mung bean protein isolates) is included in a meat analogue. In some embodiments, the meat analogue comprises one or more additional components selected from water, oil, disodium phosphate, transglutaminase, starch and salt. In some embodiments, at least or about 10% of the meat analogue is the isolated plant protein. In some embodiments, preparation of the meat analogue comprises mixing the components of the meat analogue into an emulsion and pouring the emulsion into a casing that can be tied into a chubb. In some embodiments, chubs containing the meat analogue are incubated in a water bath at 50° C. for 2 hours. In further embodiments, the incubated chubbs are pressure cooked. In some embodiments, the pressure cooking occurs at 15 psi at about 121° C. for 30 minutes.

### Food Applications: Co-Ingredients

Various gums, phosphates, starches, preservatives, and other ingredients may be included in the food compositions comprising the isolated plant protein.

Various gums useful for formulating one or more plant protein based food products described herein include, e.g., konjac, gum acacia, Versawhip, Guar+Xanthan, Q-extract, CMC 6000 (Carboxymethylcellulose), Citri-Fi 200 (citrus fiber), Apple fiber, Fenugreek fiber.

Various phosphates useful for formulating one or more plant protein based food products described herein include disodium phosphate (DSP), sodium hexamethaphosphate (SHMP), and tetrasodium pyrophosphate (TSPP).

Starch may be included as a food ingredient in the plant protein food products described herein. Starch has been shown to have useful emulsifying properties; starch and starch granules are known to stabilize emulsions. Starches are produced from plant compositions, such as, for example, arrowroot starch, cornstarch, tapioca starch, mung bean starch, potato starch, sweet potato starch, rice starch, sago starch, wheat starch.

In certain embodiments, the food compositions comprise an effective amount of an added preservative in combination with the isolated plant protein. The preservative may include ascorbic acid, citric acid, sodium benzoate, calcium propionate, sodium erythorbate, sodium nitrite, calcium sorbate, potassium sorbate, BHA, BHT, EDTA, tocopherols (Vitamin E) or antioxidants.

### Storage And Shelf Life of Food Compositions

In some embodiments, the food compositions comprising the isolated plant protein may be stable in storage at room temperature for up to 1, 2, 3, 4, 5, 6, 7, 8, 9, or 10 weeks. In some embodiments, the food compositions comprising the isolated plant protein may be stable for storage at room temperature for months, e.g., greater than 1, 2, 3, 4, 5, 6, 7, 8, 9, 10, 11, 12, or 13 months. In some embodiments, the food compositions comprising the isolated plant protein may be stable for refrigerated or freezer storage for months, e.g., greater than 1, 2, 3, 4, 5, 6, 7, 8, 9, 10, 11, 12, or 13 months. In some embodiments, the food compositions comprising the isolated plant protein may be stable for refrigerated or freezer storage for years, e.g., greater than 1, 2, 3, 4, 5, 6, 7, 8, 9, 10, 11, 12, or 13 years.

In some embodiments, storage as a dry material can increase the shelf-life of the isolated plant protein or a food composition comprising the isolated plant protein. In some embodiments, the isolated plant protein or a food composition comprising the isolated plant protein is stored as a dry material for later reconstitution with a liquid, e.g., water. In some embodiments, the isolated plant protein or the food composition is in powdered form, which may be less expensive to ship, lowers risk for spoilage and increases shelf-life (due to greatly reduced water content and water activity).

In various embodiments, a food composition (e.g., an egg-free liquid egg analog product) comprising the isolated plant protein has a viscosity of less than 500 cP after storage for thirty days at 4° C. In some cases, the composition has a viscosity of less than 500 cP after storage for sixty days at 4° C. In various embodiments, a food composition (e.g., an egg-free liquid egg analog product) comprising the isolated plant protein has a viscosity of less than 450 cP after storage for thirty days at 4° C. In some cases, the composition has a viscosity of less than 450 cP after storage for sixty days at 4° C.

Method of Controlling Hardness and/or Apparent Modulus

The present disclosure a method of controlling the hardness and/or apparent modulus of a food composition or food ingredient comprising isolated plant protein (e.g., mung bean protein isolates, that comprise native and denatured proteins). The hardness and/or apparent modulus of a food composition or food ingredient comprising isolated plant protein, the isolated plant protein comprising both native and denatured proteins, is determined by the relative amounts of native protein and denatured protein. The hardness and/or apparent modulus of the food composition or food ingredient increases with increasing amounts of native protein.

In various embodiments, the method of controlling the hardness and/or apparent modulus of a food composition or food ingredient isolated plant protein, the isolated plant protein is derived from dry beans, lentils, fava beans, dry peas, chickpeas, cowpeas, bambara beans, pigeon peas, lupins, vetches, adzuki, common beans, fenugreek, long beans, lima beans, runner beans, or tepary beans, soybeans, or mucuna beans. In various embodiments, the pulse protein isolates provided herein are derived from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some embodiments, the pulse protein isolates are derived from mung beans. In some embodiments, the mung bean is Vigna radiata. In other embodiments, the isolated plant protein may be obtained from almonds and other nuts, seeds such as sesame seeds, sunflower seeds, and other commonly consumed nuts, fruits and seeds. In various embodiments, the isolated plant protein (e.g., mung bean protein isolate) discussed herein can be produced from any source of plant protein (e.g., mung bean protein, including any varietal or cultivar of V. radiata). For example, the protein isolate can be prepared directly from whole plant material such as whole mung bean, or from an intermediate material made from the plant, for example, a dehulled bean, a flour, an air classified flour, a powder, a meal, ground grains, a cake (such as, for example, a defatted or de-oiled cake), or any other intermediate material suitable to the processing techniques disclosed herein to produce an isolated plant protein. In some embodiments, the source of the plant protein may be a mixture of two or more intermediate materials. The examples of intermediate materials provided herein are not intended to be limiting.

In various embodiments of the method of controlling the hardness and/or apparent modulus of a food composition or food ingredient comprising isolated plant protein, the isolated plant protein (e.g., mung bean protein isolate) comprises native proteins and denatured proteins. In one embodiment, the amount of the native protein, by weight, of the isolated plant protein is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%. In one embodiment, the amount of the denatured protein, by weight, of the isolated plant protein is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40% 50%.

In an embodiment of the method of controlling the hardness and/or apparent modulus of a food composition or food ingredient comprising isolated plant protein, the isolated plant protein is a globulin-type protein. In an embodiment of the method of controlling the hardness and/or apparent modulus of a food composition or food ingredient comprising isolated plant protein, the globulin-type protein is selected from the group consisting of 7S, 8S and 11S.

In some embodiments of the method of controlling the hardness and/or apparent modulus of a food composition or food ingredient comprising isolated plant protein, the hardness of the food composition or food ingredient is greater than 3 N; 5 N; 6 N; 7 N; 8 N; 9 N; 10 N; 11 N; 12 N; 13 N; 14 N; 15 N; 16 N; 17 N; 18 N; 19 N; or 20 N. In other embodiments of the method of controlling the hardness and/or apparent modulus of a food composition or food ingredient comprising isolated plant protein, the hardness of the food composition or food ingredient is between 3 N-18 N; 3 N-17 N; 3 N-16 N; 3 N-15 N; 3 N-14 N; 3 N-13 N; 3 N-12 N; 3 N-11 N; 3 N-10 N; 3 N-9 N; 3 N-8 N; 3 N-7 N; 3 N-6 N; 3 N-5 N; 3 N-4 N; 4 N-10 N; 4 N-9 N; 4 N-7 N; 4 N-6 N; or 4 N-5 N.

In some embodiments of the method of controlling the hardness and/or apparent modulus of a food composition or food ingredient comprising isolated plant protein, the apparent modulus of the food composition or food ingredient is greater than 10,000 Pa; 20,000 Pa; 30,000 Pa; 40,000 Pa; 50,000 Pa; 60,000 Pa; 70,000 Pa; 80,000 Pa; 90,000 Pa; 100,000 Pa; 110,000 Pa; 120,000 Pa; or 130,000 Pa. In other embodiments of the method of controlling the hardness and/or apparent modulus of a food composition or food ingredient comprising isolated plant protein, the apparent modulus of the food composition or food ingredient is between 10,000 Pa-130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

In some embodiments of the method of controlling the hardness and/or apparent modulus of a food composition or food ingredient comprising isolated plant protein, the isolated plant protein (e.g., mung bean protein isolate) is cross linked by contacting the plant protein with a protein cross-linking enzyme. In an embodiment the protein cross-linking enzyme or a protein cross-linking agent is selected from transglutaminase, sortase, subtilisin, tyrosinase, laccase, peroxidase, glucose oxidase or lysyl oxidase. In some embodiments the plant protein is cross-linked by contacting the plant protein with a non-enzymatic protein cross-linking agent. Non-enzymatic protein cross-linking agents use the side chains of amino acids to form covalent linkages. In an embodiment of the method of controlling the hardness and/or apparent modulus of a food composition or food ingredient comprising isolated plant protein, the amount of cross-linking enzyme of the food composition or food ingredient is between 0.0001% to 0.5%; between 0.0001% to 0.4%; between 0.0001% to 0.4%; between 0.0001% to 0.3%; between 0.0001% to 0.2%; between 0.0001% to 0.1%; between 0.0001% to 0.09%; between 0.0001% to 0.08%; between 0.0001% to 0.07%; between 0.00% to 0.06%; between 0.0001% to 0.05%; between 0.0001% to 0.04%; between 0.0001% to 0.03%; between 0.0001% to 0.01%; between 0.001% to 0.1%; between 0.001% to 0.09%; between 0.001% to 0.08%; between 0.001% to 0.07%; between 0.001% to 0.06%; between 0.001% to 0.05%; between 0.001% to 0.04%; between 0.001% to 0.03%; between 0.001% to 0.02%; between 0.001% to 0.01%; between 0.01% to 0.09%; between 0.01% to 0.08%; between 0.01% to 0.07%; between 0.01% to 0.06%; between 0.01% to 0.05%; between 0.001% to 0.04%; between 0.01% to 0.03%; or between 0.01% to 0.02%. The cross-linking enzyme is exposed to the food composition or food ingredient for a period of between 1 second and 120 minutes; between 1 second and 110 minutes; between 1 second and 100 minutes; between 1 second and 90 minutes; between 1 second and 80 minutes; between 1 second and 70 minutes; between 1 second and 60 minutes; between 1 second and 50 minutes; between 1 second and 40 minutes; between 1 second and 30 minutes; 1 between second and 10 minutes; between 1 second and 9 minutes; between 1 second and 8 minutes; between 1 second and 7 minutes; between 1 second and 6 minutes; between 1 second and 5 minutes; between 1 second and 4 minutes; between 1 second and 3 minutes; between 1 second and 2 minutes; between 1 second and 1 minute; between 1 second and 50 second; between 1 second and 40 seconds; between 1 second and 30 seconds; between 1 second and 20 seconds; between 1 second and 10 seconds; between 1 second and 5 seconds; After exposure to the cross-linking enzyme for a desired amount of time, the enzyme is inactivated by exposure to heat or other known methods of inactivating enzymes. In one embodiment, cross-linking enzyme is inactivated by exposure to high-temperature, short-time (HTST), high-temperature, long-time or other known heat exposure methods. In one embodiment, the inactivation of the cross-linking enzyme is accomplished by exposure to temperatures of between 40° C. to 100° C.; between 40° C. to 95° C.; between 40° C. to 90° C.; between 40° C. to 85° C.; between 40° C. to 80° C.; between 40° C. to 70° C.; between 40° C. to 65° C.; between 40° C. to 60° C.; between 40° C. to 55° C.; between 40° C. to 50° C.; between 40° C. to 45° C.; between 50° C. to 100° C.; between 50° C. to 95° C.; between 50° C. to 90° C.; between 50° C. to 80° C.; between 50° C. to 75° C.; between 50° C. to 70° C.; between 50° C. to 65° C.; between 50° C. to 60° C.; between 50° C. to 55° C.; between 60° C. to 100° C.; between 60° C. to 95° C.; between 60° C. to 90° C.; between 60° C. to 85° C.; between 60° C. to 80° C.; between 60° C. to 75° C.; between 70° C. to 70° C.; between 60° C. to 75° C.; between 60° C. to 70° C.; between 60° C. to 65° C.; between 70° C. to 100° C.; between 70° C. to 95 C; between 70° C. to 90° C.; between 70° C. to 85° C.; between 70° C. to 80° C.; or between 70° C. to 75° C.

### Method of Preparing a Food Composition or Food Ingredient

The present disclosure provides a method of preparing a food composition or food ingredient, the food composition or food ingredient comprising isolated plant protein (e.g., mung bean protein isolates, that comprise native and denatured proteins). The hardness and/or apparent modulus of a food composition or food ingredient comprising isolated plant protein comprising both native and denatured proteins, is determined by the relative amounts of native protein and denatured protein in the isolated plant protein. The hardness and/or apparent modulus of the food composition or food ingredient increases with increasing amounts of native protein.

In various embodiments of the method of preparing a food composition or food ingredient comprising isolated plant protein, the isolated plant protein is derived from dry beans, lentils, fava beans, dry peas, chickpeas, cowpeas, bambara beans, pigeon peas, lupins, vetches, adzuki, common beans, fenugreek, long beans, lima beans, runner beans, or tepary beans, soybeans, or mucuna beans. In various embodiments, the pulse protein isolates provided herein are derived from Vigna angularis, Vicia fava, Cicer arietinum, Lens culinaris, Phaseolus vulgaris, Vigna unguiculata, Vigna subterranea, Cajanus cajan, Lupinus sp., Vetch sp., Trigonella foenum-graecum, Phaseolus lunatus, Phaseolus coccineus, or Phaseolus acutifolius. In some embodiments, the pulse protein isolates are derived from mung beans. In some embodiments, the mung bean is Vigna radiata. In other embodiments, the isolated plant protein may be obtained from almonds and other nuts, seeds such as sesame seeds, sunflower seeds, and other commonly consumed nuts, fruits and seeds. In various embodiments, the isolated plant protein (e.g., mung bean protein isolate) discussed herein can be produced from any source of plant protein (e.g., mung bean protein, including any varietal or cultivar of V. radiata). For example, the protein isolate can be prepared directly from whole plant material such as whole mung bean, or from an intermediate material made from the plant, for example, a dehulled bean, a flour, an air classified flour, a powder, a meal, ground grains, a cake (such as, for example, a defatted or de-oiled cake), or any other intermediate material suitable to the processing techniques disclosed herein to produce an isolated plant protein. In some embodiments, the source of the plant protein may be a mixture of two or more intermediate materials. The examples of intermediate materials provided herein are not intended to be limiting.

In various embodiments of the method of preparing a food composition or food ingredient comprising isolated plant protein, the isolated plant protein (e.g., mung bean protein isolate) comprises native proteins and denatured proteins. In one embodiment, the amount of the native protein, by weight, of the isolated plant protein is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%. In one embodiment, the amount of the denatured protein, by weight, of the isolated plant protein is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

In an embodiment of the method of preparing a food composition or food ingredient comprising isolated plant protein, the isolated plant protein is a globulin-type protein. In an embodiment of the method of preparing a food composition or food ingredient comprising isolated plant protein, the globulin-type protein is selected from the group consisting of 7S, 8S and 11S.

In some embodiments of the method of preparing a food composition or food ingredient comprising isolated plant protein, the hardness of the food composition or food ingredient is greater than 3 N; 5 N; 6 N; 7 N; 8 N; 9 N; 10 N; 11 N; 12 N; 13 N; 14 N; 15 N; 16 N; 17 N; 18 N; 19 N; or 20 N. In other embodiments of the method of preparing a food composition or food ingredient comprising isolated plant protein, the hardness of the food composition or food ingredient is between 3 N-18 N; 3 N-17 N; 3 N-16 N; 3 N-15 N; 3 N-14 N; 3 N-13 N; 3 N-12 N; 3 N-11 N; 3 N-10 N; 3 N-9 N; 3 N-8 N; 3 N-7 N; 3 N-6 N; 3 N-5 N; 3 N-4 N; 4 N-10 N; 4 N-9 N; 4 N-7 N; 4 N-6 N; or 4 N-5 N.

In some embodiments of the method of preparing a food composition or food ingredient comprising isolated plant protein, the apparent modulus of the food composition or food ingredient is greater than 10,000 Pa; 20,000 Pa; 30,000 Pa; 40,000 Pa; 50,000 Pa; 60,000 Pa; 70,000 Pa; 80,000 Pa; 90,000 Pa; 100,000 Pa; 110,000 Pa; 120,000 Pa; or 130,000 Pa. In other embodiments of the a method of preparing a food composition or food ingredient comprising isolated plant protein, the apparent modulus of the food composition or food ingredient is between 10,000 Pa— 130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

In some embodiments of the method of preparing a food composition or food ingredient comprising isolated plant protein, the isolated plant protein (e.g., mung bean protein isolate) is cross linked by contacting the plant protein with a protein cross-linking enzyme. In an embodiment, the protein cross-linking enzyme or a protein cross-linking agent is selected from transglutaminase, sortase, subtilisin, tyrosinase, laccase, peroxidase, glucose oxidase or lysyl oxidase. In some embodiments the plant protein is cross-linked by contacting the plant protein with a non-enzymatic protein cross-linking agent. Non-enzymatic protein cross-linking agents use the side chains of amino acids to form covalent linkages. In an embodiment of the method of preparing a food composition or food ingredient, the amount of cross-linking enzyme of the food composition or food ingredient is between 0.0001% to 0.5%; between 0.0001% to 0.4%; between 0.0001% to 0.4%; between 0.0001% to 0.3%; between 0.0001% to 0.2%; between 0.0001% to 0.1%; between 0.0001% to 0.09%; between 0.0001% to 0.08%; between 0.0001% to 0.07%; between 0.00% to 0.06%; between 0.0001% to 0.05%; between 0.0001% to 0.04%; between 0.0001% to 0.03%; between 0.0001% to 0.01%; between 0.001% to 0.1%; between 0.001% to 0.09%; between 0.001% to 0.08%; between 0.001% to 0.07%; between 0.001% to 0.06%; between 0.001% to 0.05%; between 0.001% to 0.04%; between 0.001% to 0.03%; between 0.001% to 0.02%; between 0.001% to 0.01%; between 0.01% to 0.09%; between 0.01% to 0.08%; between 0.01% to 0.07%; between 0.01% to 0.06%; between 0.01% to 0.05%; between 0.001% to 0.04%; between 0.01% to 0.03%; or between 0.01% to 0.02%. The cross-linking enzyme is exposed to the food composition or food ingredient for a period of between 1 second and 120 minutes; between 1 second and 110 minutes; between 1 second and 100 minutes; between 1 second and 90 minutes; between 1 second and 80 minutes; between 1 second and 70 minutes; between 1 second and 60 minutes; between 1 second and 50 minutes; between 1 second and 40 minutes; between 1 second and 30 minutes; 1 between second and 10 minutes; between 1 second and 9 minutes; between 1 second and 8 minutes; between 1 second and 7 minutes; between 1 second and 6 minutes; between 1 second and 5 minutes; between 1 second and 4 minutes; between 1 second and 3 minutes; between 1 second and 2 minutes; between 1 second and 1 minute; between 1 second and 50 second; between 1 second and 40 seconds; between 1 second and 30 seconds; between 1 second and 20 seconds; between 1 second and 10 seconds; between 1 second and 5 seconds; After exposure to the cross-linking enzyme for a desired amount of time, the enzyme is inactivated by exposure to heat or other known methods of inactivating enzymes. In one embodiment, cross-linking enzyme is inactivated by exposure to high-temperature, short-time (HTST), high-temperature, long-time or other known heat exposure methods. In one embodiment, the inactivation of the cross-linking enzyme is accomplished by exposure to temperatures of between 40° C. to 100° C.; between 40° C. to 95° C.; between 40° C. to 90° C.; between 40° C. to 85° C.; between 40° C. to 80° C.; between 40° C. to 70° C.; between 40° C. to 65° C.; between 40° C. to 60° C.; between 40° C. to 55° C.; between 40° C. to 50° C.; between 40° C. to 45° C.; between 50° C. to 100° C.; between 50° C. to 95° C.; between 50° C. to 90° C.; between 50° C. to 80° C.; between 50° C. to 75° C.; between 50° C. to 70° C.; between 50° C. to 65° C.; between 50° C. to 60° C.; between 50° C. to 55° C.; between 60° C. to 100° C.; between 60° C. to 95° C.; between 60° C. to 90° C.; between 60° C. to 85° C.; between 60° C. to 80° C.; between 60° C. to 75° C.; between 70° C. to 70° C.; between 60° C. to 75° C.; between 60° C. to 70° C.; between 60° C. to 65° C.; between 70° C. to 100° C.; between 70° C. to 95 C; between 70° C. to 90° C.; between 70° C. to 85° C.; between 70° C. to 80° C.; or between 70° C. to 75° C.

### EXAMPLES

The following examples are put forth so as to provide those of ordinary skill in the art with a complete disclosure and description of how to make and use the methods and compositions of the invention, and are not intended to limit the scope of what the inventors regard as their invention. Efforts have been made to ensure accuracy with respect to numbers used (e.g., amounts, temperature, etc.) but some experimental errors and deviations should be accounted for. Unless indicated otherwise, parts are parts by weight, molecular weight is average molecular weight, temperature is in degrees Centigrade, and pressure is at or near atmospheric.

### Example 1: Ultrafiltration Process for Preparing Pulse Protein Isolates

The following example discusses an exemplary process for the production of an ultrafiltered (UF) pulse protein isolate, and also the production of an isoelectrically-precipitated (IEP) control sample for use as a comparator in following examples characterizing the properties of the UF pulse protein isolate.

Ultrafiltered Pulse Protein Isolate: 40 kg of Mung bean flour (102) that was preprocessed by drying and grinding was extracted (104) with 200 kg water, 600 g salt (NaCl), 100 mL antifoam in a Breddo liquefier (Corbion Inc). The mixing was performed for 2.5 minutes. The pH at the end of the run was adjusted to 7.0 using 1 M NaOH solution. The flour slurry (105) was then centrifuged to perform a starch solid separation (106) using a decanter (SG2-100, Alfalaval Inc). The major portion of the starch solids and unextracted material (decanter heavy phase) was separated from the liquid suspension (decanter light phase). The resuspension stream (light phase) was further clarified using a disc stack centrifuge (Clara 80, Alfalaval Inc.) into a high solids slurry (disc stack heavy phase) and a clarified resuspension (107— disc stack light phase). The disc stack heavy phase typically consists of fat, ash, starch and the protein carried over with the liquid portion of the slurry.

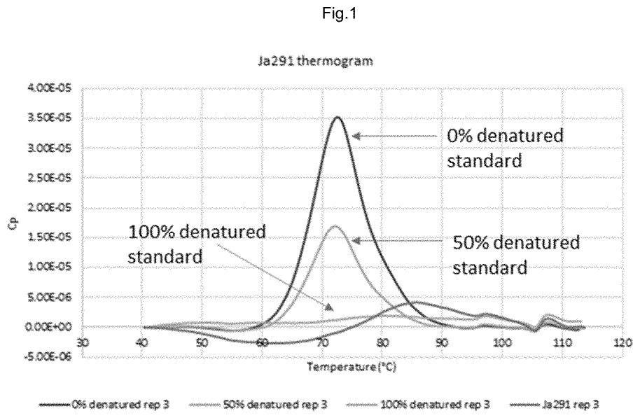

Half of the disc stack light phase (protein-rich fraction) was then processed through an ultrafiltration-diafiltration process (109) with a custom designed membrane purification unit (Alfalaval Inc.). This membrane unit was setup with a 10 kDa membrane from Alfalaval Inc. (3838RC10PP). The disc stack light phase was concentrated from 75 kg to about 20 kg (3-4× concentration). The concentrated protein suspension was further diafiltered with DI water in three steps adding about equal amount of water at each step as the concentrate weight. The stream (110) of diafiltered UF concentrate (19.5 kg) was then collected and the pH of this concentrate was adjusted (111) from 7 to 6.1 using 20% w/w citric acid solution. Salt (NaCl) was added to adjust the conductivity in the 2-3 mS/cm range and not modified. The mildly denatured protein concentrate material (112) was then heat treated (113) using a microthermics UHT unit with the pasteurization condition set at 72.5° C. and 30 sec hold time. The heat-treated material (114) was then spray dried (115) with a SPX Anhydro M400 spray dryer (GEA Niro Inc.) with the inlet temp at 180° C., outlet temp at 85° C. using a nozzle atomizer to obtain protein isolate (116). An illustration of this process, including the numbers (102-116) noted above, is shown in FIG. 1.

Isoelectrically-Precipitated Pulse Protein Isolate Control: The other half of the disc stack light phase was then transferred to the liquefier tank. The pH was adjusted to 5.6 with 20% w/w citric acid. The slurry was mixed and run through the decanter (SG2-100, Alfalaval Inc.) in recirc mode until the spin down on the decanter light phase was negligible. Then the decanter was shut down and the protein pellet collected on the decanter heavy phase side. The pellet was resuspended with 3.5× deionized water to get the concentration in the range to minimize spray drier losses. The resuspended protein solution was adjusted to a pH of 6 using 1M NaOH and salt was added to obtain the conductivity in the 2-3 mS/cm range. This material was then heat treated and spray dried to obtain an isoelectrically precipitated isolate for use as a control in Examples 3-6.

### Example 2: Protein Purification by Isoelectric Precipitations

A. Multistage extraction. Water was mixed with mung bean flour in a 5:1 tap water-to-flour ratio. The pH of the mixture was adjusted to pH 6.5-pH 8 with NaOH. The mixture was centrifuged at 6000×g for 15 minutes at 4° C. The supernatant was collected, and the pellet was resuspended in 3:1 water-to-flour. The pH of the resuspended pellet was adjusted to pH 6.5-pH 8 with NaOH, and centrifuged again at 6000×g for 15 minutes at 4° C. Both supernatants were combined and filtered through 100 um Nylon mesh.

B. Acid Precipitations. Isoelectric precipitation at pH 5.6+/−0.2 is combined with a cryo-precipitation method at 1-4° C. The pH of the combined supernatant was brought down to pH 5.4-5.8 with 20% Citric Acid and cooled on ice for 1 h. Alternatively, low ionic strength precipitation can be performed at very high flow rates combined with cryo-precipitation method (at 1-4° C.). Rapid dilution of the filtrate from the 100 um Nylon mesh step was performed in cold (4° C.) 0.3% NaCl at a ratio of 1 volume of filtrate to 3 volumes of cold 0.3% NaCl. The filtrate was then centrifuged at 10,000×g for 15 minutes at 4° C. to precipitate the protein.

C. Recovery. The pellet containing the isolated protein was collected, resuspended and homogenized 1:4 (w/w) with 0.3% NaCl (4° C.). The pH was maintained at 5.6+/−0.1 with citric acid. The suspension was again centrifuged at 10,000×g for 15 minutes at 4° C., and the final pellet containing the isolated protein was homogenized before use.

### Example 3: Determination of Native and Denatured State of Protein Denaturation of Protein Isolate

Mung bean protein isolate sample DD26 was prepared according to the Example 2 and DSC thermagrams were obtained. The DSC for DD26 prior to denaturation shows a sharp single peak with a Tm at 72° C. showing that the protein is not denatured (native).

For denatured protein standards used in differential scanning calorimetry (DSC) experiments a denatured protein stock sample was made by resuspending DD26, a protein isolate powder that functions well in egg products in 60 mM sodium carbonate buffer, pH 9.2, to 0.5 mg/mL protein, then placing the protein solution in a 95° C. water bath for 20 minutes. The denatured stock protein was then cooled to 4° C. on ice and kept as the 100% denatured stock solution.

The denatured protein stock was then mixed with the undenatured (native) DD26 in various proportions to generate standard samples for DSC analysis that have varying amounts of denatured protein (0, 50, and 100%). These samples were then analyzed using the DSC assay as described below to generate thermal stability curve standards as discussed below.

For the denatured protein isolates used in the experiments disclosed in Example 4, the denatured stock protein solution was resuspended in dH₂O at 6% w/w. The resuspended isolate was placed in bottles inside a 95° C. water bath for 20 minutes with stirring at 100 rpm using a magnetic stir bar. After incubation the samples were cooled, homogenized, then spray dried to remove water and form a denatured protein isolate powder. The spray dried denatured protein was named Ja291.

### Differential Scanning Calorimetry

Differential scanning calorimetry (DSC) experiments were used to determine if a batch of isolate that underwent the denaturing procedure performed was fully denatured relative to a native standard. DSC experiments were performed using a Malvern MicroCal VP Capillary DSC. To obtain a melting curve to determine protein thermal stability the samples underwent a heat ramp from 40° C. to 115° C. with a temperature ramp of 240° C./hour. Heat capacity measurements were taken every 10 seconds over the course of the temperature ramp. All samples were analyzed in triplicate with a buffer blank subtracted from the thermogram.

FIG. 1 shows a large peak for the 100% native protein standard (DD26) with a melting temperature (Tm) of 72° C. The sample made with 50% native protein and 50% denatured protein has a peak of approximately half the intensity and the same Tm of 72° C. The 100% denatured sample does not show a sharp peak or discernible thermal transition (Tm).

The large batch denatured isolate (Ja291) used to perform Young's modulus experiments show a similar curve to the 100% denatured sample. Notably, there is no peak with a Tm at or near 72° C. and no discernible thermal transition, demonstrating that the protein is either completely or near completely denatured.

### Example 4: Denatured Protein and Texture Quality

Various ratios of denatured mung bean protein isolate, Ja291, and native mung bean protein isolate, DD26, were mixed in tap water using a Thermomix TM5 kitchen mixer (Vorwerk & Co, Germany) on medium shear speed for 5 minutes to prepare a 13.3 w/w % solution. For ease of sample handling and consistency, 0.6 w/w % soy lecithin was added as a defoamer. Protein samples, containing native and denatured protein with the following ratios 100:0, 75:25, 50:50, 25:75, 0:100, were prepared. Round screw container (Hicarer, China) of 1.5 inches diameter and 1.2 inches height were sprayed with a short spray of vegetable oil for easier release of the sample after the water bath step. 7 g of sample was weighed into the screw container, and the containers were placed on a tray with lid tightly screwed on. Another tray was added on top to hold the sample cups in place so that the tray was fully submerged in the water bath. This set up was placed in the 85° C. hot water bath (Sous Vide Supreme, Broomfield, USA) for 45 minutes. After incubating for 45 minutes, the samples were cooled down at ambient temperature with closed lid for at least 1 hour. The solidified samples were removed from the screw container and a puncture test was performed by a CT3 Texture Analyzer (Brookfield Engineering, Middleboro) with a cylinder probe (TA-4, diameter 1.5 inches). A two-cycle texture profile analysis (TPA) test was performed by measuring 70% deformation at a trigger load of 0.05 N, and test speed of 1.00 mm/s. Hardness value was defined as the peak force (g) at maximum deformation. Apparent modulus for elasticity (Pa), which is the slope of a linear portion of the stress vs. strain curve during the first compression stroke, was obtained using the TexturePro CT V1.8 software. Each protein dispersion of different ratios of native and denatured protein was analyzed in triplicates.

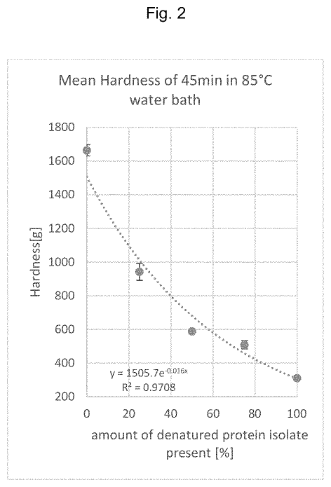

The results showed that hardness and apparent modulus for elasticity (Young's modulus) both decrease with increased amount of denatured protein isolate. FIG. 2 shows that the hardness of the protein composition increases with increasing amounts of native protein, and the protein composition decreases with decreasing amounts of denatured protein. A food composition comprising 100% Native protein has a hardness of 16.5 N. A food composition comprising 75% native protein has a hardness 9.3 N. A food composition comprising 25% native protein has a hardness is 5.2 N.

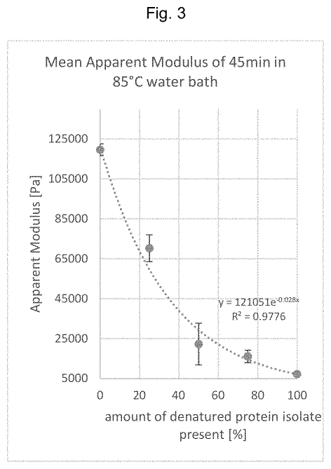

FIG. 3 shows the apparent modulus of varying the amounts of native versus denatured protein in a food composition. A food composition comprising native protein has an apparent modulus of 119,555 Pa. A food composition comprising 75% native protein has an apparent modulus is 70,228 Pa. A food composition comprising 25% native protein has an apparent modulus of 16,063 Pa.

### Example 5: Size Exclusion Chromatography

Size exclusion chromatography was performed as another method of determining the amounts of native and denatured protein of an isolated plant protein. For samples used in size exclusion chromatography (SEC) experiments, DD26 as described in Example 3 was resuspended in 60 mM sodium carbonate-sodium bicarbonate, pH 9.2, to 1.5 mg/mL protein to prepare native protein stock solution. Samples were vortexed to aid in solubilization of the protein. After solubilization, the protein stock was centrifuged at 4700 rpm for 15 minutes at 4° C. to remove any insoluble material. The native protein stock (DD26) was then heat denatured over a 20-minute time course by heating in a 95° C. heat block. The denatured protein samples were then cooled to 4° C. on ice to stop the thermal denaturation process. The protein samples were then filtered through a 0.2 μm syringe filter and injected on the HPLC for SEC analysis as described below. The denatured protein stock solution was named Ja291.

High performance liquid chromatography (HPLC) was carried out on an Agilent Infinity LC Series 1260 Infinity II Quaternary system with a size exclusion column (Waters ACQUITY UPLC® Protein BEH SEC, 200 A, 1.7 μm, 4.6×300 mm). A 100 mM potassium phosphate, pH 7.0 solvent was used as the mobile phase. Samples were injected (10 μL) and run at a flow rate of 0.4 mL/min isocratically for 20 min. The column was held at 40° C. Detection of eluants was measured by absorbance at 214 and 280 nm.

The 8S globulin is a storage protein that makes up a large majority of proteins, up to 90% of the globulins, present in mung beans. The 8S globulin protein has a molecular weight of about 150 kDa and is a trimer of three subunits, 8Sα, 8Sα′ and 8Sβ, with each subunit comprising several proteins. Denaturing polyacrylamide gel electrophoresis indicates that the proteins that make up 8S have molecular weights of 60, 48, 32 and 26 kDa. Heat denatured samples (Ja291) were compared to native samples (DD26) to monitor denaturation of protein over time. In the 0-minute sample, which underwent no heat treatment, a peak is observed at a size of approximately 150 kD, which corresponds to the expected molecular weight of 8S globulin protein in the native state. Upon exposure to heat, the peak corresponding to 8S globulin diminishes almost entirely after 10 minutes of heat treatment. Correspondingly, as the 150 kD 8S globulin peak diminishes, a new peak emerges at a size greater than 660 kD, larger than the resolution range of the column used. Protein species this size are larger than any known native state proteins present in mung bean isolate. This demonstrates the formation of large, denatured protein aggregates forming from denatured 8S globulin protein molecules upon heat treatment. Further, Ja291, displays no peak corresponding to native 8S globulin, corroborating the DSC experiments of Example 3 where no thermal transition for Ja291 protein was observed.

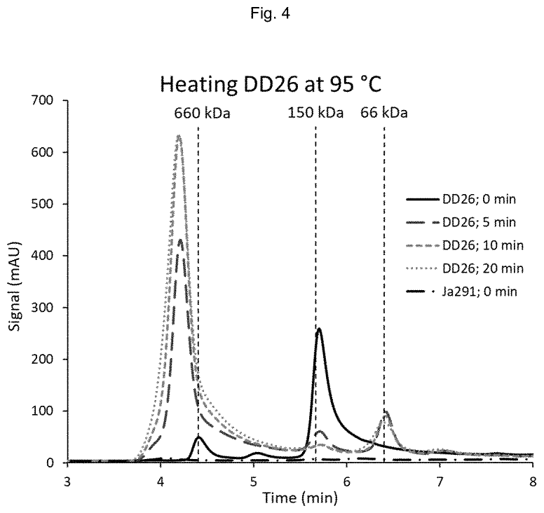

The SEC chromatogram is shown in FIG. 4. Native 8S globulin protein elutes at a molecular weight of approximately 150 kD. Upon heating and denaturation of the proteins, this peak disappears, and a large peak appears in the void volume (MW>660 kD), indicating the formation of denatured protein aggregates upon heat treatment at 95° C. FIG. 4 shows that the proteins that elute in the void volume elutes at approximately 4.4 minutes with a molecular weight of 660 kD, native 8S protein that elutes at approximately 5.6 minutes has a molecular weight of 150 kD, and 8S protein monomer, with an approximate molecular weight of 66 kD that elutes at 6.4 minutes.

### Solubility Assay

Solubility measurements were performed to determine if the proteins present in an isolated plant protein are native. Denatured proteins form insoluble aggregates are not soluble or sparingly soluble. To prepare samples for solubility measurements, 600 mg of protein isolate was weighed out into a 50 mL conical tube. 40 mL of buffer was added to the tube, then stirred using a small spatula or stir rod to solubilize the isolate. After mixing and solubilizing the isolate the samples where then centrifuged at 4700 rpm for 15 min at 4° C. to remove any insoluble material. The supernatant containing the soluble protein was then decanted into an aluminum drying pan and the mass was recorded. Samples were then placed in an oven set to 105° C. and dried for a minimum of 15 hours. After drying, the mass of the remaining solids was measured, and the total amount of soluble isolate was calculated.

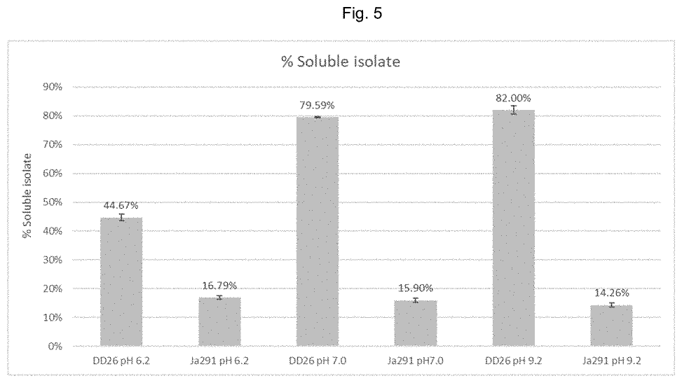

Solubility of DD26, a protein that is mostly in the native state was compared to JA291, a denatured protein isolate. Solubility was tested over three buffer conditions: pH 6.2 (0.3% NaCl, 0.3% tetrasodium pyrophosphate, 0.15% tri-potassium citrate), pH 7 (100 mM potassium phosphate), and pH 9.2 (60 mM sodium carbonate-sodium bicarbonate). Under all conditions, DD26 displayed significantly higher solubility, with the pH 7.0 and 9.2 conditions displaying approximately 80% solubility for DD26 as compared to approximately 15% for JA291. This is shown in FIG. 5.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

### Example 6: Soy Protein

### Extraction+Denaturation

Water was mixed with soybean (Glycine max) flour in a 5:1 water-to-flour ratio. The pH of the mixture was adjusted to pH 8.5 with 1 M NaOH. The mixture was centrifuged at 6000×g for 15 minutes at 4° C. The supernatant was collected and diluted in a 1:4 supernatant-to-water ratio. The diluted supernatant was split into two fractions.

The pH of the first fraction was brought down to pH 4.5 with 50% citric acid and then centrifuged at 10,000×g for 15 minutes at 4° C. to precipitate the protein. The pellet containing the native isolated protein was collected and stored at 4° C. The pellet was used within a week of collection.

The second fraction of the diluted supernatant was heated at 95° C. for 20 min in a Thermomix TM5 kitchen mixer (Vorwerk & Co, Germany) and cooled on ice to prepare denatured soy protein isolate. The pH was brought down to pH 4.5 with 50% citric acid and then centrifuged at 10,000×g for 15 minutes at 4° C. to precipitate the protein. The pellet containing the denatured protein was collected and stored at 4° C. The pellet was used within a week of collection.

### Size Exclusion Chromatography

Size exclusion chromatography (SEC) was performed as a method for determining the degree of denaturation of isolated soybean protein samples. For samples used in SEC experiments, native and denatured soy protein pellet samples were resuspended at 1% total solid in 60 mM sodium carbonate-sodium bicarbonate at pH 9.2. Samples were vortexed to aid in solubilization of the protein. After solubilization, the protein samples were filtered through a 0.2 μm syringe filter and injected on the HPLC for SEC analysis as described below.

High performance liquid chromatography (HPLC) was carried out on an Agilent Infinity LC Series 1260 Infinity II Quaternary system with a size exclusion column (Waters ACQUITY UPLC© Protein BEH SEC, 450 Å, 2.5 μm, 4.6 mm×300 mm). A 100 mM potassium phosphate buffer at pH 7.0 was used as the mobile phase. Samples were injected (10 μL) and run at a flow rate of 0.4 mL/min isocratically for 20 min. The column was held at 40° C. Detection of eluants was measured by absorbance at 214 and 280 nm.

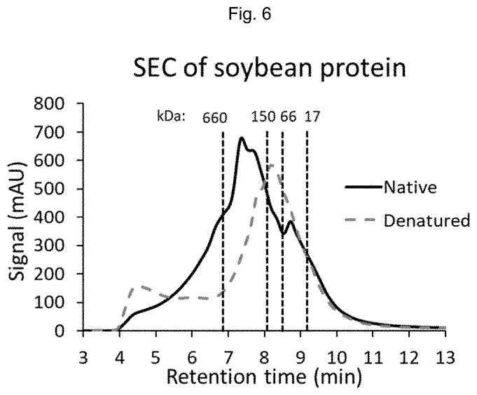

The SEC chromatogram is shown in FIG. 6. Native legumin (11S) soybean protein elutes at a molecular weight of approximately 350 kDa and native vicilin (7S) soybean protein elutes at as molecular weight of approximately 170 kDa. FIG. 6 shows that the proteins in the unheated, native sample elute at 7.3 min (legumin) and 7.7 min (vicilin). In the heated, denatured sample, these peaks have disappeared or decreased and there is an increase in the peak size of the denatured protein that elutes at 8.3 min.

### Differential Scanning Calorimetry

Differential scanning calorimetry (DSC) experiments were used to determine if a sample of extracted soybean protein that underwent the denaturing procedure was fully denatured relative to a native control. DSC experiments were performed using a Malvern MicroCal VP Capillary DSC. For samples used in DSC experiments, native and denatured protein pellet samples were resuspended at approximately 0.5 mg/mL of protein in water. To obtain a melting curve to determine protein thermal stability the samples underwent a heat ramp from 40 to 115° C. at a rate of 240° C./h. Heat capacity measurements were taken every 10 s over the course of the temperature ramp. All samples were analyzed in duplicate with a buffer blank subtracted from the thermogram.

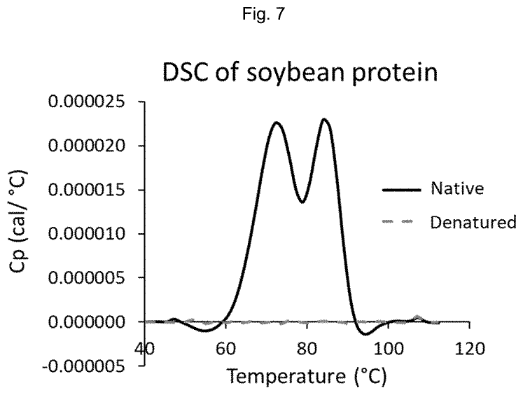

FIG. 7 shows that the native protein has two peaks with melting temperatures (Tm) of 72 and 83° C.; these peaks correspond to the expected thermal transition associated with conformational changes of vicilin and legumin proteins, respectively. The denatured sample did not show a peak or discernible thermal transition showing that the protein treated with heat at 95° C. for 20 min was denatured.

### Gelation and Hardness

Slurries of 13% total protein were prepared by mixing the native soybean protein pellet and the denatured soybean protein pellet in water using an immersion blender to homogenize the slurries. The pH was adjusted to 6.7 for each prepared sample. Protein samples containing native and denatured protein with the following native: denatured ratios were prepared: 100:0, 80:20, 60:40, 40:60, 20:80, 0:100. 6-well plates (Corning Costar® 6 well plate, with lid; flat bottom; ultra-low attachment surface) were sprayed with a short spray of vegetable oil for easier release of the gelled sample. 10 g of each of the protein samples were weighed into the wells; the lid of the plate was put in place and waterproof tape was put around the edge of the plate to seal the lid to the plate. Plates were placed in a 90° C. water bath (Sous Vide Supreme, Broomfield, USA) for 30 min. After heating for 30 min, the samples were opened and cooled down at ambient temperature for at least 15 min. The solidified (gelled) samples were removed from the 6-well plates and left at ambient temperature for another 15 min. Using a CT3 Texture Analyzer (Brookfield Engineering, Middleboro) with a cylinder probe (TA-4, diameter 1.5 in), a one cycle texture profile analysis (TPA) test was performed by measuring 50% deformation at a trigger load of 1 g (0.0098 N) and a speed of 1.00 mm/s. The hardness value was defined as the peak force (g) at maximum deformation. Each protein sample of different ratios of native and denatured protein were analyzed in triplicate.

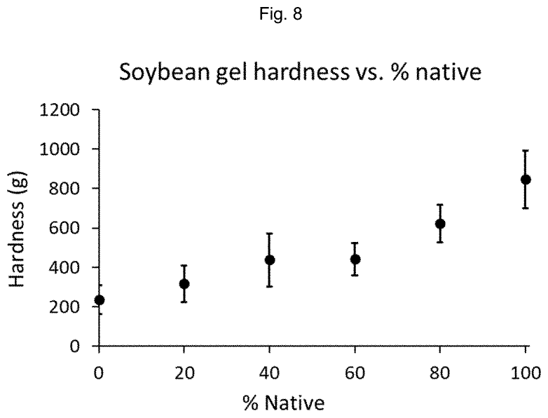

FIG. 8 shows that hardness of the protein gel increases with increasing amounts of native soybean protein. A food composition composing 100% native protein has a hardness of 847 g (8.30 N). A food composition composing 80% native protein and 20% denatured protein has a hardness of 623 g (6.11 N). A food composition composing 60% native protein and 40% denatured protein has a hardness of 442 g (4.33 N). A food composition composing 40% native protein and 60% denatured protein has a hardness of 438 g (4.29) N. A food composition composing 20% native protein and 80% denatured protein has a hardness of 317 g (3.11 N). A food composition composing 0% native protein and 100% denatured protein has a hardness of 235 g (2.30 N).

### Example 7: Chickpea Protein

### Extraction and Denaturation

Water was mixed with chickpea (Cicer arietinum) flour in a 5:1 water-to-flour ratio. The pH of the mixture was adjusted to pH 8.5 with 1 M NaOH. The mixture was centrifuged at 6000×g for 15 minutes at 4° C. The supernatant was collected and diluted in a 1:4 supernatant-to-water ratio. The diluted supernatant was split into two fractions.

The pH of the first fraction was brought down to pH 6 with 50% citric acid and then centrifuged at 10,000×g for 15 minutes at 4° C. to precipitate the protein. The pellet containing the isolated protein was collected and stored at 4° C. The pellet was used within a week of collection.

The second fraction of the diluted supernatant was heated at 95° C. for 20 min in a Thermomix TM5 kitchen mixer (Vorwerk & Co, Germany) and cooled on ice to prepare denatured chickpea protein isolate. The pH was brought down to pH 6 with 50% citric acid and then centrifuged at 10,000×g for 15 minutes at 4° C. to precipitate the protein. The pellet containing the denatured protein was collected and stored at 4° C. The pellet was used within a week of collection.

### Size Exclusion Chromatography

Size exclusion chromatography (SEC) was performed as a method for determining the degree of denaturation of isolated chickpea protein samples. For samples used in SEC experiments, native and denatured chickpea protein pellet samples were resuspended at 1% total solid in 60 mM sodium carbonate-sodium bicarbonate at pH 9.2. Samples were vortexed to aid in solubilization of the protein. After solubilization, the protein samples were filtered through a 0.2 μm syringe filter and injected on the HPLC for SEC analysis as described below.

High performance liquid chromatography (HPLC) was carried out on an Agilent Infinity LC Series 1260 Infinity II Quaternary system with a size exclusion column (Waters ACQUITY UPLC© Protein BEH SEC, 450 Å, 2.5 μm, 4.6 mm×300 mm). A 100 mM potassium phosphate buffer at pH 7.0 was used as the mobile phase. Samples were injected (10 μL) and run at a flow rate of 0.4 mL/min isocratically for 20 min. The column was held at 40° C. Detection of eluants was measured by absorbance at 214 and 280 nm.

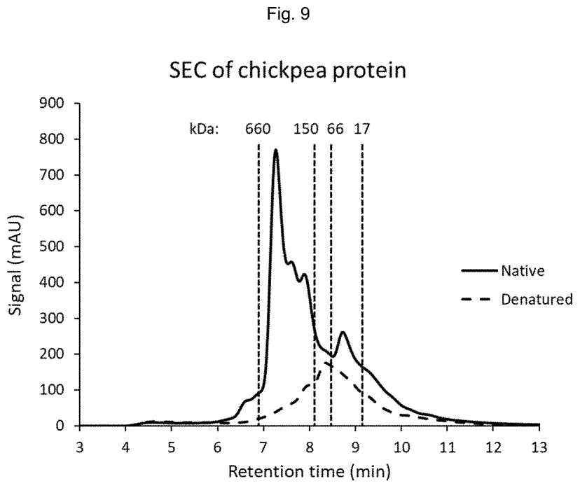

The SEC chromatogram is shown in FIG. 9. Native legumin (11S) chickpea protein elutes at a molecular weight of approximately 350 kDa and native vicilin (7S) chickpea protein elutes at as molecular weight of approximately 150 kDa. FIG. 9 shows that the proteins in the unheated, native sample elute at 7.3 min (legumin) and 7.9 min (vicilin). In the heated, denatured sample, these peaks have disappeared or decreased and there is an increase in the peak size of the denatured protein monomers that elutes at 8.4 min.

### Differential Scanning Calorimetry

Differential scanning calorimetry (DSC) experiments were used to determine if a sample of extracted chickpea protein that underwent the denaturing procedure was fully denatured relative to a native control. DSC experiments were performed using a Malvern MicroCal VP Capillary DSC. For samples used in DSC experiments, native and denatured protein pellet samples were resuspended at approximately 0.5 mg/mL of protein in water. To obtain a melting curve to determine protein thermal stability the samples underwent a heat ramp from 40 to 115° C. at a rate of 240° C./h. Heat capacity measurements were taken every 10 s over the course of the temperature ramp. All samples were analyzed in duplicate with a buffer blank subtracted from the thermogram.

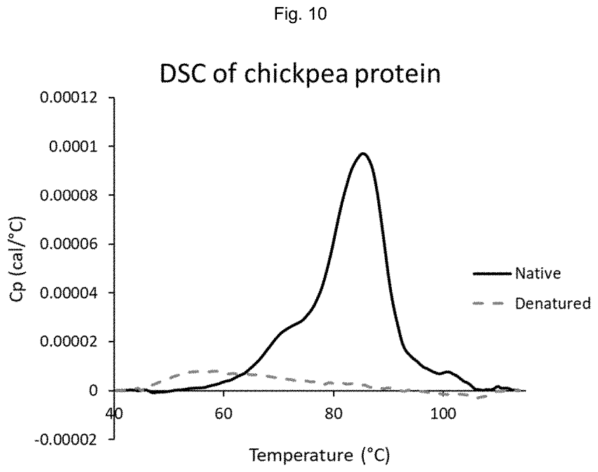

FIG. 10 shows that the native protein has one main peak with a melting temperature (Tm) of 85° C. and a smaller shoulder with a Tm of 73° C.; these peaks correspond to the expected thermal transition associated with conformational changes of legumin and vicilin proteins, respectively. The denatured sample did not show a peak or discernible thermal transition showing that the protein treated with heat at 95° C. for 20 min was denatured.

### Gelation and Hardness

Slurries of 13% total protein were prepared by mixing the native chickpea protein pellet and the denatured chickpea protein pellet in water using an immersion blender to homogenize the slurries. The pH was adjusted to 6.7 for each prepared sample. Protein samples containing native and denatured protein with the following native; denatured ratios were prepared: 100:0, 80:20, 60:40, 40:60, 20:80, 0:100. 6-well plates (Corning Costar® 6 well plate, with lid; flat bottom; ultra-low attachment surface) were sprayed with a short spray of vegetable oil for easier release of the sample. 10 g of each of the protein samples were weighed into the wells; the lid of the plate was put in place and waterproof tape was put around the edge of the plate to seal the lid to the plate. Plates were placed in a 95° C. water bath (Sous Vide Supreme, Broomfield, USA) for 60 min. After heating for 60 min, the samples were opened and cooled down at ambient temperature for at least 15 min before being stored at 4° C. for 16 h. The solidified samples were removed from the 6-well plates and left at ambient temperature for another 15 min. Using a CT3 Texture Analyzer (Brookfield Engineering, Middleboro) with a cylinder probe (TA-4, diameter 1.5 in), a one cycle texture profile analysis (TPA) test was performed by measuring 50% deformation at a trigger load of 1 g (0.0098 N) and a speed of 1.00 mm/s. The hardness value was defined as the peak force (g) at maximum deformation. Each protein sample of different ratios of native and denatured protein were analyzed in triplicate.

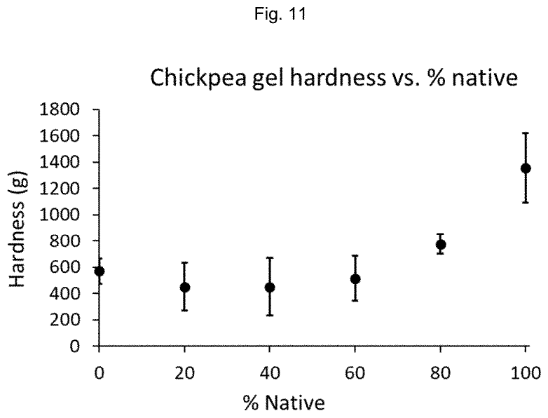

FIG. 11 shows that hardness of the protein gel increases with increasing amounts of native chickpea protein. A food composition composing 100% native protein has a hardness of 1357 g (13.3 N). A food composition composing 80% native protein and 20% denatured protein has a hardness of 775 g (7.60 N). A food composition composing 60% native protein and 40% denatured protein has a hardness of 515 g (5.05 N). A food composition composing 40% native protein and 60% denatured protein has a hardness of 452 g (4.43 N). A food composition composing 20% native protein and 80% denatured protein has a hardness of 450 g (4.41 N). A food composition composing 0% native protein and 100% denatured protein has a hardness of 570 g (5.59 N).

1. An isolated plant protein, the isolated protein comprising both native and denatured proteins, wherein the amount of the native protein, by weight, is between 20% to 95%, and wherein the hardness of the protein increases with increasing amounts of native protein or the apparent modulus of the protein increases with increasing amounts of native proteins.

2. The isolated plant protein of claim 1, wherein the hardness of the protein increases with increasing amounts of native proteins.

3. The isolated plant protein of claim 1, wherein the apparent modulus of the protein increases with increasing amounts of native proteins.

4. The isolated plant protein of claim 1, wherein the hardness and the apparent modulus of the protein increase with increasing amounts of native proteins.

5. (canceled)

6. (canceled)

7. The isolated plant protein of claim 1, wherein the amount of the native protein by weight, is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

8. (canceled)

9. (canceled)

10. (canceled)

11. (canceled)

12. The isolated plant protein of claim 1, wherein
a. the hardness of the plant protein is between 300 g-1800 g; 300 g-1700 g; 300 g-1600 g; 300 g-1500 g; 300 g-1400 g; 300 g-1300 g; 300 g-1200 g; 300 g-1100 g; 300 g-1000 g; 300 g-900 g; 300 g-800 g; 300 g-700 g; 300 g-600 g; 300 g-500 g; 300 g-400 g; 400 g-1000 g; 400 g-900 g; 400 g-800 g; 400 g-700 g; 400 g-600 g; or 400 g-500 g; and/or
b. the apparent modulus of the plant protein is between 10,000 Pa-130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

13. (canceled)

14. (canceled)

15. A food composition or a food ingredient comprising an isolated plant protein, wherein the isolated plant protein comprises both native and denatured proteins, wherein the amount of the native protein, by weight, is between 20% to 95%, and wherein the hardness of the food composition or food ingredient increases with increasing amounts of native protein or the apparent modulus of the protein increases with increasing amounts of native proteins.

16. (canceled)

17. (canceled)

18. (canceled)

19. (canceled)

20. (canceled)

21. The food composition or food ingredient of claim 15, wherein the amount of the native protein by weight, is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

22. (canceled)

23. (canceled)

24. (canceled)

25. (canceled)

26. The food composition or food ingredient of claim 15, wherein
a. the hardness of the food composition or food ingredient is between 300 g-1800 g; 300 g-1700 g; 300 g-1600 g; 300 g-1500 g; 300 g-1400 g; 300 g-1300 g; 300 g-1200 g; 300 g-1100 g; 300 g-1000 g; 300 g-900 g; 300 g-800 g; 300 g-700 g; 300 g-600 g; 300 g-500 g; 300 g-400 g; 400 g-1000 g; 400 g-900 g; 400 g-800 g; 400 g-700 g; 400 g-600 g; or 400 g-500 g; and/or
b. the apparent modulus of the food composition or a food ingredient is between 10,000 Pa-130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

27. (canceled)

28. (canceled)

29. A method of controlling the hardness and/or apparent modulus of a food composition or food ingredient, the food composition or food ingredient comprising an isolated plant protein, the method comprising the steps of:
a. providing isolated plant proteins that comprise both native and denatured proteins;
b. identifying the desired hardness and/or apparent modulus of the food composition or food ingredient; and
c. determining the amount of native protein to achieve the desired hardness and/or apparent modulus, wherein the amount of the native protein, by weight is between 20% to 95%, and
wherein the hardness and/or apparent modulus of the food composition or food ingredient increases with increasing amounts of native protein used to prepare the food composition or food ingredient.

30. The method of claim 29, wherein the hardness of the food composition or food ingredient increases with increasing amounts of native protein.

31. The method of any claim 29, wherein the apparent modulus of the food composition or food ingredient increases with increasing amounts of native proteins.

32. The method of claim 29, wherein the hardness and the apparent modulus of the food composition or food ingredient increases with increasing amounts of native proteins.

33. (canceled)

34. (canceled)

35. The method of claim 29, wherein the amount of the native protein by weight, is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

36. (canceled)

37. (canceled)

38. (canceled)

39. (canceled)

40. The method of claim 29, wherein
a. the hardness of the food composition or food ingredient is between 300 g-1800 g; 300 g-1700 g; 300 g-1600 g; 300 g-1500 g; 300 g-1400 g; 300 g-1300 g; 300 g-1200 g; 300 g-1100 g; 300 g-1000 g; 300 g-900 g; 300 g-800 g; 300 g-700 g; 300 g-600 g; 300 g-500 g; 300 g-400 g; 400 g-1000 g; 400 g-900 g; 400 g-800 g; 400 g-700 g; 400 g-600 g; or 400 g-500 g; and/or
b. the apparent modulus of the food composition or food ingredient is between 10,000 Pa-130,000 Pa; 10,000 Pa-120,000 Pa; 10,000 Pa-110,000 Pa; 10,000 Pa-100,000 Pa; 10,000 Pa-90,000 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa;
20,000 Pa-70,000 Pa; 20,000 Pa-60,000 Pa; 20,000 Pa-50,000 Pa; or 20,000 Pa-40,000 Pa.

41. (canceled)

42. (canceled)

43. A method of preparing a food composition or a food ingredient having a desired hardness and/or apparent modulus, the method comprising the steps of:
a. providing isolated plant proteins that comprise both native and denatured proteins;
b. identifying the desired hardness and/or apparent modulus of the food composition or food ingredient;
c. determining the amount of native protein to achieve the desired hardness and/or apparent modulus, wherein the amount of the native protein, by weight is between 20% to 95%; and
wherein the hardness and/or apparent modulus of the food composition or food ingredient increases with increasing amounts of native protein used to prepare the food composition or food ingredient.

44. The method of claim 43, wherein the hardness of the food composition or food ingredient increases with increasing amounts of native proteins.

45. The method of claim 43, wherein the apparent modulus of the food composition or food ingredient increases with increasing amounts of native proteins.

46. The method of claim 43, wherein the hardness and the apparent modulus of the food composition or food ingredient increases with increasing amounts of native proteins.

47. (canceled)

48. (canceled)

49. The method of claim 43, wherein the amount of the native protein by weight, is between 20%-95%; 25%-95%; 30%-95%; 35%-95%; 40%-95%; 45%-95%; 50%-95%; 55%-95%; 60%-95%; 65%-95%; 70%-95%; 75%-95%; 80%-95%; 85%-95%; 90%-95%; 25%-75%; 25%-50%; 30%-75%; 30%-50%; 40%-75%; 40%-70%; 40%-60%; or 40%-50%.

50. (canceled)

51. (canceled)

52. (canceled)

53. (canceled)

54. The method of claim 43, wherein
a. the hardness of the food composition or food ingredient is between 300 g-1800 g; 300 g-1700 g; 300 g-1600 g; 300 g-1500 g; 300 g-1400 g; 300 g-1300 g; 300 g-1200 g; 300 g-1100 g; 300 g-1000 g; 300 g-900 g; 300 g-800 g; 300 g-700 g; 300 g-600 g; 300 g-500 g; 300 g-400 g; 400 g-1000 g; 400 g-900 g; 400 g-800 g; 400 g-700 g; 400 g-600 g; or 400 g-500 g; and/or
b. the apparent modulus of the plant protein is between 10,000 Pa-130,000 Pa; 10,000 Pa-120,000 Pa; 10,000 Pa-110,000 Pa; 10,000 Pa-100,000 Pa; 10,000 Pa-90,000 Response to Notice to File Missing Parts Attorney Docket No. 116377.00108 Pa; 10,000 Pa-80,000 Pa; 10,000 Pa-70,000 Pa; 10,000 Pa-60,000 Pa; 10,000 Pa-50,000 Pa; 10,000 Pa-40,000 Pa; 10,000 Pa-30,000 Pa; 10,000 Pa-20,000 Pa; 20,000 Pa-130,000 Pa; 20,000 Pa-100,000 Pa; 20,000 Pa-90,000 Pa; 20,000 Pa-80,000 Pa; 20,000 Pa-70,000 Pa; 20,000 Pa-60,000 Pa; 20,000 Pa-50,000 Pa; or 20,000 Pa-40,000 Pa.

55. (canceled)

56. (canceled)
